(19) United States
(12) Patent Application Publication
(10) Pub. No.: US 2009/0252323 A1
(43) Pub. Date: Oct. 8, 2009

(54) METHODS, TECHNIQUES AND SYSTEM FOR MAINTAINING SECURITY ON COMPUTER SYSTEMS

(76) Inventor: Simon COOPER, Ashdod (IL)

Correspondence Address: Pearl Cohen Zedek Latzer, LLP, 1500 Broadway, 12th Floor, New York, NY, 10036, US

(21) Appl. No.: 12/414,799

(22) Filed: Mar. 31, 2009

Related U.S. Application Data
(60) Provisional application No. 61/041,945, filed on Apr. 3, 2008.
(60) Provisional application No. 61/052,208, filed on May 11, 2008.

(51) Int. Cl. G09C 5/00; G06F 17/30

(52) U.S. Cl. 380/54; 707/3; 707/E17.014

(57) ABSTRACT

A hardware device that includes a first interface, a second interface, at least one memory unit, a data analyzer circuitry, and decryption circuitry. The first interface receives image information that is sent to a display. The data analyzer circuitry analyzes the image information to detect encrypted image information. The decryption circuitry decrypts the detected encrypted image information to provide the decrypted image information to replace the encrypted image information to provide modified image information. The second interface sends the modified image information to the display so that the display displays a modified image. The at least one memory unit stores at least a portion of at least one out of the image information, the modified image information and at least one decryption key.

### CROSS REFERENCE TO RELATED APPLICATIONS

This application claims the benefit of U.S. Provisional Patent Application No. 61/041,945, filed on Apr. 3, 2008 and U.S. Provisional Patent Application No. 61/052,208, filed on May 11, 2008, both of which are incorporated in their entirety herein by reference.

### FIELD OF THE INVENTION

This invention relates generally to the field of information security and more specifically, to maintaining security of sensitive information from being accessed by unauthorized users.

### BACKGROUND OF THE INVENTION

Typically, personal computer systems, that could also be referred to as client computers, and, additionally or alternatively, client workstations, could be connected to other computing systems and, additionally or alternatively, computing servers via various types of networks, for example Internet, Local Area Network LAN, Wide Area Network WAN, direct link and, additionally or alternatively, other types of networks and, additionally or alternatively, combination of several types of networks.

Typically, for example, there is a need to provide techniques, methods, and, additionally or alternatively, systems for securing data exchange between various computer systems over network and, additionally or alternatively, for securing access to data on computer systems, for example in order prevent the exchanged, and, additionally or alternatively, accessed data from being accessed by unauthorized users, for example preventing from unauthorized users access for viewing, and, additionally or alternatively, modifying, and, additionally or alternatively, emulating the data.

Typically, for example, unauthorized users (hackers) could apply various hacking techniques in order to gain access to sensitive data exchanged between computer systems, and, additionally or alternatively, sensitive data accessed on computer systems. For example, unauthorized users could gain access to sensitive data via network, and, additionally or alternatively, via gaining physical access to the computer systems that have access to sensitive data. For example, unauthorized users could gain access to data exchanged over network between client and server computer systems, by gaining access to client computer system, for example via network, in a manner for example that enables unauthorized users to monitor, and, additionally or alternatively, modify, and, additionally or alternatively, emulate data stored on and, additionally or alternatively, accessed from client computer system.

Conveniently, various methods, techniques and, additionally or alternatively, systems could be applied at preventing unauthorized users from gaining access to computer systems and, additionally or alternatively, data exchanged between computer systems via network. For example, connection between computer systems could be established in an encrypted manner that, for example, ensures data validity, and, additionally or alternatively, integrity, and, additionally or alternatively, secrecy, for example by using protocols such as Secure Socket Layer SSL, yet another example, by connecting to network through firewalls that could form boundaries between various networks, yet another example, by applying various security methods, techniques, and, additionally or alternatively, systems aimed at preventing, and, additionally or alternatively, detecting unauthorized users access.

Typically, for example, it's relatively easier for unauthorized users to gain access to client computer then to decrypt encrypted data transferred over network, and, additionally or alternatively, gain access to server computer systems, for example personal computer (client computer) running Windows operating system could be vulnerable to hacking via network.

For example, unauthorized users could gain various levels of access to client computer system. For example, unauthorized users could gain access to monitor, and, additionally or alternatively, modify, and, additionally or alternatively, emulate data stored on client computer, and, additionally or alternatively, accessed from client computer. Yet, as another example, unauthorized users could gain access to client computer system in a manner that enables unauthorized users to emulate input data of various input devices, for example mouse and, additionally or alternatively, keyboard input devices, on client computer in a manner that the emulated input data to be accepted (perceived) by client computer system, and, additionally or alternatively, server computer system as valid input data from client computer system input device such as mouse, and, additionally or alternatively, keyboard.

Yet as another example, unauthorized user could gain access to client computer, for example in a manner similar to remote terminal, that could enable unauthorized user to perceive data displayed on client computer display, and, additionally or alternatively, access data stored on client computer system, and, additionally or alternatively, access through client computer system to various server systems over network, and, additionally or alternatively, emulate inputs from keyboard and, additionally or alternatively, mouse devices linked to the client computer system. Yet, as another example, unauthorized user could use gained access to client computer to access though such client computer to various server systems in a manner that such access would be perceived, for example by server computer as legitimate (valid) client access.

Yet, as another example, unauthorized user could gain unauthorized access to sensitive data, for example such as credit card information that could be entered by user on client computer system, and, additionally or alternatively, user bank account information that could be accessed by legitimate user through client computer.

In order to explain the present invention FIG. 1 illustrates an exemplary general block diagram of typical client computer system connected to server computer system over network, as known in the art.

Conveniently, as illustrated in FIG. 1, client computer system 1, that could also be referred to as client workstation 1, and, additionally or alternatively, personal computer 1, could include a mouse device 7, and, additionally or alternatively, keyboard device 8, and, additionally or alternatively, graphical display device 6, and could include a computer 9 for example personal computer 9 and, additionally or alternatively, laptop 9. As illustrated in FIG. 1, client computer system 1, and, additionally or alternatively, server computer system 12, and, additionally or alternatively, unauthorized user computer system 3 could be interconnected via network 5.

Conveniently, graphical data stream from client computer 9 to display device 6, could be logically divided into frames of graphical data where each frame could represent a full image scan (view), for example of desktop view, while various frame resolutions are possible. For example typical frame resolution (width and height in pixels), for example of desktop view, may vary from 800×600 to 1600×1200 and more pixels per frame, while the rate of frames per second in graphical data stream could be referred to as refresh rate, for example typically refresh rate is between sixty and hundred times a second.

Conveniently, graphical data stream received from graphical circuitry 58 of client computer 9 could be in digital, for example DVI, and, additionally or alternatively, analog, for example VGA, format.

Conveniently, in operation, the graphical circuitry 58 of computer 9 could be providing video images in the form of graphical data stream, through for example DVI interface, the graphical data stream could be then logically divided into frames of graphical data, where each frame could represent pixel data of a single full desktop view image 51. This graphical data may be provided in a variety of different resolutions, which may depend upon the settings or configuration parameters within the client computer 9, the resolution is based on a combination of the horizontal pixels and vertical pixels utilized to present the video image 51. This resolution may be defined by a standard, such as Video Graphics Array (“VGA”), and, additionally or alternatively, may be referenced by the number of pixels in each row and column utilized to present the graphical data, such as 1280×1024 or 1600×1200. For example, each pixel in the video image may be represented by one or more colors and each color may be represented by one or more bits of color information, for example a pixel may be represented by three colors, red, green and blue and each of these three colors may be represented by eight bits of color information.

Continently, for example a resolution of 1600×1200 utilizes about 1.92 million storage elements for the individual pixels, where individual pixel data may contain twenty four bits of color data, for example of red, green and blue colors, for example eight bits of data per each of the three colors. Frame data could be transmitted more then once per second, the number of frames transmitted per second could be referred to as refresh rate, for example refresh rate could be between sixty and hundred times per second for example to maintain the video images on the display device 6.

Conveniently, client computer system 1, server computer system 12, and, additionally or alternatively, unauthorized user computer system 3 could be physically located in the same or different places, and, additionally or alternatively, areas. Conveniently, server computer system 12 could be part of server area 2.

Conveniently, as illustrated in FIG. 1, data 20 stored on server computer system 12 could be accessed from client computer 9 over network 5, and exchanged, for example in form of data packets 16, containing data in various formats, for example text, graph, image, table, etc.

Conveniently, as illustrated in FIG. 1, data received in data packet/s 16 on client computer 9 from server computer 12 could be graphically represented as image 19 and displayed on client computer system 1 display device 6.

As illustrated in FIG. 1, unauthorized user via computer-based 11 system 3, for example by applying various hacking techniques, could gain access over network 5 or by other means, to client computer 9 in a manner that unauthorized user could gain access, for example to received by client computer 9 data packet/s 16, and, additionally or alternatively, to various data that could be accessed on or via client computer 9. For example, as illustrated in FIG. 1, unauthorized user could then graphically represent data in data packet/s 16, and, additionally or alternatively, various other data from client computer 9, on his/hers computer system 11 display, for example in a similar manner to how its graphically represented 19 on display device 6 of client computer system 1.

For example, unauthorized user could gain access to view, and, additionally or alternatively, modify data, for example data in data packet/s 16, and, additionally or alternatively, various data accessed on or via client computer 9, for example on his/hers computer system 11. Conveniently, unauthorized user could display data in data packet/s 16 from client computer system 1 in graphical representation 19 similar to graphical representation 19 on client computer system 1 display 6. Yet, another example, unauthorized user could gain access to emulate various input data on client computer system 1 to be perceived as input data form various input devices, for example keyboard device 8, and, additionally or alternatively, mouse device 7.

Conveniently, unauthorized user by accessing (hacking) to client computer 9 could view data, for example documents, stored on server 12, and, additionally or alternatively, for example modify them by emulating keystrokes of client workstation 1 keyboard device 8, and, additionally or alternatively, movements and, additionally or alternatively, clicks of mouse device 7 in a manner that could be perceived by server computer system 12 as valid data.

Conveniently, network 5 could be Internet, Local Area Network LAN, Wide Area Network WAN, and, additionally or alternatively, other type of network, and, additionally or alternatively, combination of several networks.

Although, in this embodiment, for example the server computer system 12 is illustrated in FIG. 1 as single computer system 12, it should be understood that additional computer-based systems, located in server area 2, and, additionally or alternatively, in various other locations, could be part of server computer system 12 connected, for example over network 5, to form the server computer system 12, can also be provided. In particular, the server computer system 12 could include, for example, various storage devices, and, additionally or alternatively, computer systems running various applications that could respectively interconnect to form server computer system 12.

Although, in this embodiment, for example unauthorized user access is illustrated in FIG. 1 to be performed from computer system 11, it should be understood that unauthorized user access could take various forms, for example of malicious application running on client computer 9. Yet as another example, unauthorized user could gain physical access to client workstation 1, and, additionally or alternatively, client computer 9.

### SUMMARY OF THE INVENTION

A hardware device that includes a first interface, a second interface, at least one memory unit, a data analyzer circuitry, and decryption circuitry. The first interface receives image information that is sent to a display. The data analyzer circuitry analyzes the image information to detect encrypted image information. The decryption circuitry decrypts the detected encrypted image information to provide the decrypted image information to replace the encrypted image information to provide modified image information. The second interface sends the modified image information to the display so that the display displays a modified image. At least one memory unit stores at least a portion of at least one out of the image information, the modified image information and at least one decryption key.

A method for secure communication that includes: receiving by first interface of a hardware device, image information that is sent to a display; analyzing, by a data analyzer circuitry of the hardware device, the image information to detect and validate encrypted image information; decrypting, by a decryption circuitry of the hardware device, the encrypted image information to provide decrypted image information; modifying, by the hardware device, the decrypted data information to provide modified decrypted image information; replacing, by the hardware device, the encrypted image information by the modified decrypted image information to provide modified image information; sending, by a second interface of the hardware device, the modified image information to the display so that the display displays a modified image information; storing, in at least one memory unit of the hardware device, at least a slice of the image information and the modified image information and storing at least one decryption key.

### BRIEF DESCRIPTION OF THE DRAWINGS

FIG. 1 schematically illustrates an example block diagram of client server computer systems interconnecting over network, as known in the art, in which the present invention may be implemented;

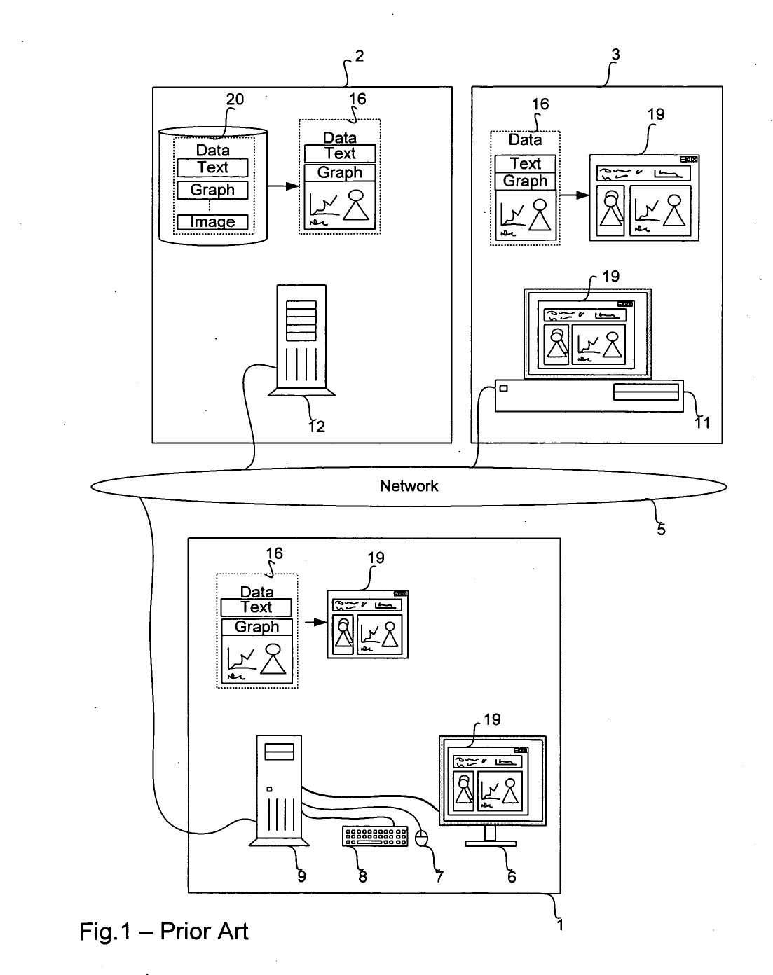

FIG. 2 schematically illustrates an example block diagram of client server computer systems interconnecting over network that could include client workstation enhancement security device and security enhancement server, according to one embodiment of the invention;

FIG. 3 illustrates an exemplary flow diagram of data exchange between client and server computer systems that could include at least the acts of: graphically representing various data as plain image/s, and, additionally or alternatively, encrypting plain image pixel data, and, additionally or alternatively, detecting encrypted image/s, and, additionally or alternatively, decrypting encrypted image/s pixel data, according to another embodiment of the invention;

FIG. 4 illustrates an exemplary flow diagram of plain image conversion into encrypted image according to another embodiment of the invention.

FIG. 5 logically illustrates exemplary flow technique for plain image conversion into encrypted image according to another embodiment of the invention;

FIG. 6 illustrates exemplary graphical representation view of computer desktop view that could include full or partial graphical representation of encrypted image, and, additionally or alternatively, instructions and data embedded in graphical data of an icon according to another embodiment of the invention;

FIG. 7 illustrates an exemplary schematic block diagram of client computer security enhancement device according to another embodiment of the invention;

FIG. 8 illustrates an exemplary flow diagram of general techniques that could be used by client computer security enhancement device to capture, process and transmit graphical data stream that could include representation of encrypted images, according to another embodiment of the invention;

FIG. 9 illustrates an exemplary perspective view of computer system with client computer security enhancement devices and client security enhancement dongle device, according to another embodiment of the invention;

FIG. 10 illustrates an exemplary perspective view of computer system with client computer security enhancement device and client security enhancement dongle device and mouse device and keyboard device, according to another embodiment of the invention;

FIG. 11 illustrates an exemplary perspective view of computer system with client computer security enhancement device embodied as desktop box and client security enhancement dongle devices, according to another embodiment of the invention;

FIG. 12 illustrates an exemplary perspective view of graphical card with client computer security enhancement device, according to another embodiment of the invention;

FIG. 13 schematically illustrates an example block diagram of client server computer systems interconnecting over network that could include client workstation enhancement security device and client security enhancement dongle device, according to another embodiment of the invention;

FIG. 14 schematically illustrates an example block diagram of client computer system that could include client workstation enhancement security device and client security enhancement dongle device, according to another embodiment of the invention;

### DETAILED DESCRIPTION OF VARIOUS EMBODIMENTS

This invention relates generally to the field of information security and more specifically, to maintaining secure access and exchange of information between various computer-based systems connected over network, for example for maintaining secure access and exchange of information between client computer system and server computer system, having for example server computer system and client computer system and network connections.

More specifically, the invention relates to methods, techniques and systems for maintaining the security of data processed, and, additionally or alternatively, exchanged in a computer-based environment and in particular, to methods, techniques and systems for maintaining the security of access from client computer system to data stored on server computer system, for example via network, and graphical representation of such data on display system of client computer system, and, additionally or alternatively, to methods, techniques and systems for maintaining secure data input from for example a user on client computer system, such methods, techniques and systems for example could aim at preventing unauthorized user (hacker) access for example via network to the data on client computer system, and, additionally or alternatively, on server computer system.

Conveniently, maintaining secure access and exchange of information could be associated with providing data confidentiality, and, additionally or alternatively, integrity, and, additionally or alternatively, validity. Conveniently, the client computer system typically could be a personal computer and, additionally or alternatively, laptop running typically windows based operating system. Conveniently, the network, for example, could be associated with Internet, Local Area Network LAN, Wide Area Network WAN, direct link and, additionally or alternatively, other types of networks and, additionally or alternatively, combination of several types of networks. Conveniently, data exchange between client and server computer systems could be associated, for example, with accessing from client computer to various data stored on server computer over network, for example Internet, and, additionally or alternatively, sending various sensitive data (for example credit card information) from client computer to server computer over network.

The invention can be implemented in numerous ways. For example, the invention can be implemented as circuit, chip, device, system, application, firmware, and, additionally or alternatively, method. Several embodiments of the invention are discussed below.

Conveniently, the invention provides techniques and methods for representing data 20, that could be stored on server system 12, as graphical representation plain image 14, and, additionally or alternatively, converting such plain image 14 into encrypted image 15, for example by substitution of pixel data in plain image 14 with encrypted pixel data, for example such conversion of plain image 14 into encrypted image 15 could be applied to prevent unauthorized user access to the data 20 graphical representation that represented by pixel data of plain image 14, and more particularly encrypted image 15 could represent plain image 14 in a manner that could prevent from unauthorized users viewing plain image 14, and, additionally or alternatively, modifying or emulating encrypted image 15 in a manner that could produce an encrypted image 15 that could be perceived as valid data by the computer systems exchanging data 20.

Conveniently, a hardware device is provided. It includes a first interface, a second interface, a memory unit, a data analyzing circuitry, a data decrypting and processing circuitry, and a non-volatile memory unit. The first interface captures graphical information that is sent by graphical circuitry of a computer of a user to a display. The data analyzing circuitry analyzes the pixel data of the captured graphical information searching for encrypted image information within the pixel data of a single graphical frame of such captured graphical information and verifies integrity of such detected encrypted image information. The data decrypting and processing circuitry processes detected and verified encrypted image information and modifies the captured graphical information to provide modified graphical information. The second interface sends the modified graphical information to the display so that the display displays modified graphical information. The memory unit stores at least one of the rows of pixel data of a singe frame of the graphical information and stores at least one of the rows of pixel data of a singe frame of the modified graphical information. The non-volatile memory unit stores at least a single decryption key applied by a data processing unit in decrypting the encrypted image information.

Conveniently, a hardware device is provided. It includes a first interface, a second interface, a memory unit, a data analyzer circuitry, and a decryption circuitry. The first interface captures video steam information that is sent by graphical circuitry of a computer to a display. The data analyzing circuitry analyzes pixel data of the captured video steam information searching for encrypted image information within the pixel data of a single video frame of such captured video stream information and verifies integrity of such encrypted image information. The data decrypting and processing circuitry processes detected encrypted image information and modifies the captured video stream information according to instructions and encrypted data in the encrypted image information to provide modified video stream information. The second interface sends the modified video stream information to the display so that the display displays a modified video stream. The memory unit stores at least one of the rows of pixel data of a singe video frame of the video stream information and stores at least one of the rows of pixel data of a singe video frame of the modified video stream information; and stores at least a single decryption key applied by data processing unit in decrypting data imbedded in the encrypted image information.

Conveniently, the hardware device can be a hardware plug that connects between the display output interface of a computer and a video data input interface of a display.

Conveniently, the hardware device can also be an integrated circuit or an integrated circuitry of graphical interface circuitry, that is embedded in a computer of a user and connects between computer's graphical circuitry and computers display output interface.

Conveniently, the hardware device includes at least one port for providing connectivity with peripheral input devices of a user and/or with peripheral input devices interface of a computer of a user. The port can provide connectivity with peripheral USB device. The port that is connected to the peripheral input devices interface of a computer of a user can provide power and/or uplink for the hardware device.

Conveniently, the memory unit or a portion thereof can be embedded in a dongle that has an interface for providing connectivity to a computer of a user.

Conveniently, the data analyzing circuitry can analyze the captured video stream information looking for predefined pixel data patterns within a single display view frame that are indicative of encrypted image information. The predefined pixel data pattern includes at least one data entity indicating the correct decryption key to be applied on the encrypted imbedded data, a height and width of encrypted image information, a seed data applied at decrypting the encrypted image, instruction data indicating the manner the encrypted image information should be processed, parity data verifying validity and integrity of encrypted image, hardware device identifying data that provides information about the addressed hardware device to process the encrypted image information.

Conveniently, the data analyzing circuitry can analyze the captured graphical information searching for predefined pixel data patterns within a single frame that are indicative of encrypted image information; wherein the predefined pixel data pattern comprises at least one data entity selected from decryption key pointer, a height and width of encrypted image information, a seed data, an instruction data, a parity data, a hardware device pointer.

Conveniently, the data analyzing circuitry can determine whether the image information is representative of an image that includes only a portion of the encrypted image or if the image information includes overlaid pixels that represent encrypted image pixels and overlaid graphics.

Conveniently, the data analyzing circuitry can perform error detection checks of the encrypted image data information to determine whether the data is fully valid or just partially valid, which parts are valid and which parts of encrypted image information are overlaid by other graphical pixel data.

Conveniently, the data analyzing circuitry can determine if a slice of pixel information of the graphical information represents an encrypted image pixels by applying pattern detection by applying CRC value calculation on part of the pixel information to provide an CRC value result and comparing the CRC value result to part of the pixel information that if the pixels are representative of encrypted image would store an expected CRC value result value.

Conveniently, the data processing circuitry applies error detection and/or correction coding on the encrypted image information.

Conveniently, the data processing circuitry applies error correction and/or decompression coding on the decrypted image information.

Conveniently, the encrypted image information of a first image is representative of an instruction that can be applied in processing encrypted image information of a second image.

Conveniently, the encrypted image information of a first image can also be representative of an instruction and encrypted data that provides a means for adding or replacing decryption keys in the non-volatile memory unit.

Conveniently, the hardware device can generate modified image information without decrypted image information if the data analyzer determines that the image information is representative of an image that includes only a portion of the encrypted image.

Conveniently, the decryption circuitry can apply error correction coding on the encrypted image information and/or on the decrypted image information.

Conveniently, the encrypted image information of a first image is representative of an encryption instruction that assists the decryption circuitry to decrypt encrypted image information of a second image.

Conveniently, the encrypted image information of a first image is representative of an encryption instruction that points to a location of a decryption key in the memory unit.

Conveniently, the encrypted image information includes multiple slices, and thus the decryption circuitry decrypts one slice after the other.

Conveniently, the data processing circuitry processes the encrypted image information by performing instruction decoding, decryption of valid slices, error correction, de-scrambling and substitution of encrypted image information within the captured video steam information with the processed encrypted image information. The de-scrambling can be hash-based.

Conveniently, the modified image information causes the display to display an encryption icon. The modified image information includes encryption icon information that includes a decryption instruction and the encryption icon information causes the display to display an encryption icon.

Conveniently, a method for secure communication is provided. The method includes: receiving by first interface of a hardware device, graphical information that is sent to a display; analyzing, by a data analyzer circuitry of the hardware device, the graphical information to detect encrypted image information within the pixel data of the captured graphical information; verifying, by a data analyzer circuitry of the hardware device, the detected encrypted image information to verify integrity and validity of encrypted image information; decrypting, by a decrypting circuitry of the hardware device, the data in encrypted image information to provide decrypted image information; replacing, by the hardware device, the encrypted image information with the decrypted data image information to provide modified graphical information; sending, by a second interface of the hardware device, the modified graphical information to the display so that the display displays a modified graphical information; storing, in a memory unit of the hardware device, at least a portion of at least one out of the image information and the modified image information; storing, at least a portion of at least one out of the captured graphical information and modified graphical information in memory unit of the hardware device; and storing, in a non-volatile memory unit of the hardware device, at least one decryption key.

Conveniently, a method for secure communication is provided. The method includes: receiving by first interface of a hardware device, image information that is sent to a display, analyzing, by a data analyzer of the hardware device, the image information to detect encrypted image information, decrypting, by a decryption circuitry of the hardware device, the encrypted image information to provide decrypted image information, replacing, by the hardware device, the encrypted image information by the decrypted image information to provide modified image information, sending, by a second interface of the hardware device, the modified image information to the display so that the display displays a modified image and storing, in a memory unit of the hardware device, at least a portion of at least one out of the image information and the modified image information.

Conveniently, a method for secure communication is provided. The method includes: receiving by first interface of a hardware device, video steam information that is sent to a display, analyzing, by a data analyzer of the hardware device, the video steam information to detect encrypted image information within the pixel data of the captured video stream information in form of encrypted image, decrypting, by a data processing circuitry of the hardware device, the data in encrypted image information to provide decrypted image information, replacing, by the hardware device, the encrypted image information with the decrypted data image information to provide modified video steam information, sending, by a second interface of the hardware device, the modified video steam information to the display so that the display displays a modified video steam information, storing, the captured video stream information and the processed encrypted image information and modified video stream information in memory unit of the hardware device and storing, in a non-volatile memory unit of the hardware device, at least one decryption key to be applied in decrypting the encrypted image information.

Conveniently, in some embodiments of the invention security enhancement server 13 could be provided that could perform data 20 representation as graphical image 14 and, additionally or alternatively, could perform conversion of plain image 14 into encrypted image 15, by taking for example the acts of; plain image 14 pixel data truncation, truncated plain image 14 pixel data encryption, CRC calculation of encryption digest (output of encryption), header data generation, substitution of plain pixel data in plain image 14 with encryption digest, CRC calculation result, and header data in order to form encrypted image 15.

Conveniently, in some embodiments of the invention security enhancement server 13 could be implemented as separate computer-based system, and, additionally or alternatively, application running on server 12, and, additionally or alternatively, device connected to server 12, and, additionally or alternatively, part of circuitry of server 12, and, additionally or alternatively, daughter card in server 12, and, additionally or alternatively, chip.

Conveniently, security enhancement server 13 could be located in same physical and, additionally or alternatively, logical server area 2 as server 12, and, additionally or alternatively, in different server area 4.

Conveniently, such encrypted images 15 could be send by server 12 computer systems via network 5 to client 1 computer system 1, and such encrypted images 15 could be displayed by client computer 9 as graphical representation image on desktop view 51 of client computer system 1.

Conveniently, in some embodiments of the invention client workstation enhancement security device 10 could be provided and could for example perform encrypted image 15 decryption by taking for example the acts of; capturing graphical data stream transmitted by client computer 9, detecting and processing various embedded instructions in graphical data stream, detecting encrypted images 15 in captured graphical data stream, decrypting (converting) encrypted image 15 pixel data into decrypted image 14 pixel data, substituting in captured graphical data stream encrypted image 15 pixel data with decrypted pixel data, transmitting processed graphical data stream for example in DVI format to for example display device 6. Conveniently, graphical data stream transmitted by client computer 9 could be in DVI format, DisplayPort format, and, additionally or alternatively, analog VGA format, and for example such graphical data stream could represent desktop view 51, and for example such desktop view 51 could include graphical representation of encrypted image 15.

Conveniently, in some embodiments of the invention client workstation enhancement security device 10 could be implemented as separate computer-based system, and, additionally or alternatively, device, and, additionally or alternatively, circuit that could be for example part of graphical circuitry 58 of computer 9, and, additionally or alternatively, chip, and, additionally or alternatively, daughter card in computer 9, and, additionally or alternatively, part of display 6 circuitry.

Conveniently, client workstation enhancement security device 10 could be part of client workstation 1 system.

As a method for data representation as encrypted image 15, one embodiment of the invention includes at least the acts of: plain image 14 pixel data truncation, truncated plain image 14 pixel data encryption, CRC calculation of encryption digest (output of encryption), header data generation, substitution of plain pixel data in plain image 14 with encryption digest, CRC calculation result, and header data.

As a method for extraction of plain image 14 from encrypted image 15, one embodiment of the invention includes at least the acts of: capturing graphical data stream transmitted by client computer 9, detecting and processing various embedded instructions in graphical data stream, detecting encrypted images 15 in captured graphical data stream, decrypting (converting) encrypted image 15 pixel data into decrypted image 14 pixel data, substituting in captured graphical data stream encrypted image 15 pixel data with decrypted pixel data, transmitting processed graphical data stream.

Conveniently, for example the invention provides techniques and methods for secure data exchange between client 1 and server 2 computer systems that aims at preventing unauthorized users 3 to perceive exchanged data 16, by having the data converted into encrypted image 15 for example by security enhancement server 13, and then sent as encrypted image 15 via network 5 to client computer system 1, then computer 9 could be displaying the encrypted image 15 on desktop view 51 and transmitting as graphical data stream for example in DVI format, then client workstation enhancement security device 10 could capture the graphical data stream from computer 9, then client workstation enhancement security device 10 could detect, validate, decrypt and substitute the encrypted image 15 pixel data with decrypted image 14 pixel data, then client workstation enhancement security device 10 could transmit the processed graphical data stream for example to display device 6.

Conveniently, for example the present invention provides techniques and methods for maintaining integrity, validity and, additionally or alternatively, confidentiality of data 20 that could be stored on server 12 computer-based systems and accessed by client 1 computer-based systems, for example via network 5. Conveniently, the provided method could include the acts of; all or parts of data 20 in various formats for example text, graph, etc. to be graphically represented as plain image 14, then encrypting plain pixel data of plain image 14 by applying various encryption techniques, then substituting the plain pixel data in the plain image 14 with the pixel data encryption digest, then embedding various header data in pixel data of the image for example by substitution, and, additionally or alternatively, addition of pixel data in image.

Conveniently, in other embodiments of the present invention, client workstation enhancement security device 10 could provide signature adding to data from input devices, such as a mouse device 7, and, additionally or alternatively, keyboard device 8, Conveniently, the client workstation enhancement security device 10 could be intercepting the input data as it comes directly from the input device such as keyboard or mouse, adding various signature data to captured data and transmitting the data to host device for example to client computer 9. Conveniently, such signature could be applied for example for preventing unauthorized users emulating and, additionally or alternatively, monitoring input data from such input devices by embedding in such signature data that could identify the client workstation enhancement security device 10 generated the signature, time of signature generation, and, additionally or alternatively, signed symbol, click or movement applied by user. For example, to data representing keystroke from a particular keyboard device 8, could be added data representing sequence of emulated keystrokes that for example could function as a signature. Yet as another example, to data representing click or movement from a particular mouse device 7, could be added data representing sequence of emulated movements that for example could function as a signature. Conveniently, in some embodiments of the invention, encrypted image 15 decryption, and, additionally or alternatively, input device signature generation could be preformed by single client workstation enhancement security device 10.

Conveniently, one of embedded instructions that could be processed by client workstation enhancement security device 10 could cause client workstation enhancement security device 10 to substitute pixel data of such specific embedded instruction with client workstation enhancement security device 10 unique identification number.

Conveniently, in some embodiments of client workstation enhancement security device 10 for example an I2C link of DVI interface could be used to establish exchange of data between various applications that could run on client computer 9 and client workstation enhancement security device 10.

Conveniently, as a method, random login verification number and, additionally or alternatively, letter could be graphically represented and embedded in encrypted image 15, then user could be asked to type in the login verification number and, additionally or alternatively, letter to login, this for example could prevent from unauthorized users to login since they can't see the decryption result of encrypted image 15 that contains the graphical representation of the login verification number and, additionally or alternatively, letter.

Conveniently, as a method for entering numerical data in a secure manner, for example credit card number, randomly generated numbers could be embedded in encrypted image 15 and sent to client workstation 1, then the user could, in various ways, provide the difference of each displayed random number from the desired to enter by him. For example, a number “7” could be randomly generated by server 12 and graphically imbedded in encrypted image 15, then such image could be set to client computer 9, displayed on desktop view 51, processed by client workstation enhancement security device 10 and displayed on display device 6 of client workstation 1 to graphically display the digit “7” in a secure manner, then the user that wants to enter for example a digit value of “3” could for example click that the digit he wants to enter is the displayed digit minus four.

Conveniently, in some embodiments of client workstation enhancement security device 10 the device could process compressed, for example in JPEG format, images. For example encrypted image 15 could contain data of JPEG file data that represents plain image 14.

Conveniently, one of embedded instructions that could be processed by client workstation enhancement security device 10 could cause client workstation enhancement security device 10 to embed, for example by substitution, in captured graphical stream a cursor graphical representation, from preset cursor graphical representation image, in the instructed, by such instruction, location in captured graphical stream.

Additional aspects, features and advantages of the present invention can be had from the following detailed description of exemplary embodiments thereof, which description should be read along with reference to the accompanying drawings.

These and other objects of the invention will be appreciated by a review of the drawings and of the following detailed description of various embodiments.

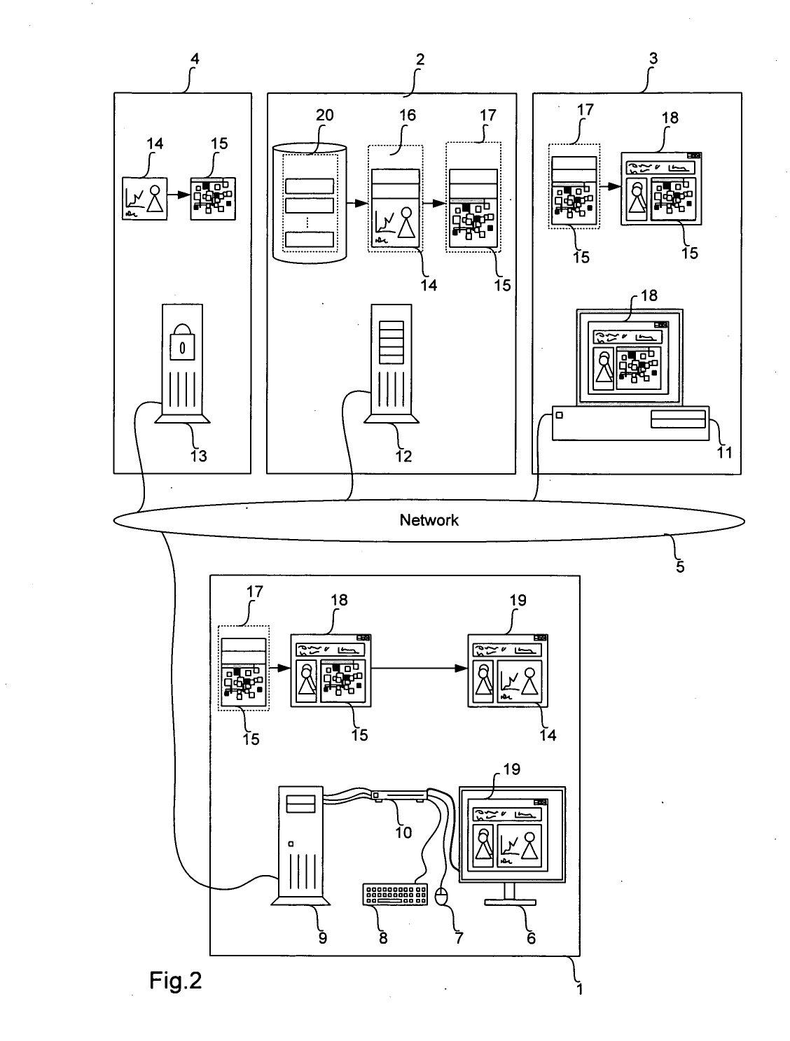

Embodiments of this aspect of the invention are discussed below with reference to FIGS. 2 through 14. However, those skilled in the art will readily appreciate that the detailed description given herein with respect to these figures is for explanatory purposes as the invention extends beyond these limited embodiments.

The invention can be implemented in numerous ways, such as, an application, system, apparatus, device, circuit, technique and method. Several exemplary embodiments of the invention are discussed below.

Conveniently, FIG. 2 illustrates an exemplary block diagram of computer-based systems connecting over network 5 according to one embodiment of the invention, provides security enhancement server 13, and, additionally or alternatively, provides client workstation enhancement security device 10, and, additionally or alternatively, provides method and, additionally or alternatively, technique for maintaining secure data access and, additionally or alternatively, data exchange between computer-based systems.

Conveniently, although security enhancement server 13 is illustrated in FIG. 2 as separate computer-based system it should be understood that security enhancement server 13 could be computer-based server 13 that could connect with server 12 over network 5, and, additionally or alternatively, security enhancement server 13 could be application running on server 12, and, additionally or alternatively, security enhancement server 13 could be device connected to server 12, and, additionally or alternatively, security enhancement server 13 could be part of circuitry of server 12, and, additionally or alternatively, security enhancement server 13 could be a daughter card in server 12, and, additionally or alternatively, security enhancement server 13 could be a chip.

Conveniently, security enhancement server 13 could be located in same physical and, additionally or alternatively, logical server area 2 as server 12, and, additionally or alternatively, in different server area 4.

Conveniently, as illustrated in FIG. 2 client computer-based workstation 1 could include a mouse device 7, and, additionally or alternatively, keyboard device 8, and, additionally or alternatively, display device 6 and could be based on personal computer 9, and, additionally or alternatively, laptop 9 and could include a client workstation security enhancement device 10.

Conveniently, client workstation security enhancement device 10 could be connected to display device 6, and, additionally or alternatively, keyboard device 8, and, additionally or alternatively, mouse device 7, and personal (client) computer 9 in a manner that enables client workstation security enhancement device 10 capturing, buffering, analyzing, processing, modifying, and, additionally or alternatively, adding data to data transferred between personal (client) computer 9 and keyboard device 8, and, additionally or alternatively, mouse device 7, and, additionally or alternatively, display device 6.

Conveniently, in client workstation system 1 one or more client workstation security enhancement devices 10 could be present in various embodiments, and could be connected in parallel, and, additionally or alternatively, serially to each other.

Conveniently, client workstation security enhancement device 10 could be implemented as device connecting to keyboard device 8, and, additionally or alternatively, mouse device 7, and, additionally or alternatively, monitor device 6, and computer 9, and, additionally or alternatively, implemented as part of circuitry of computer 9, and, additionally or alternatively, implemented as part of circuitry of display device 6.

Conveniently, as illustrated in FIG. 2 typical client workstation 1 could be connected to server 12 that could be located in server area 2, over network 5. Conveniently, although, as illustrated in FIG. 2 for example, the server system 12 is illustrated as computer-based server 12, it should be understood that additional computer-based systems, located in server area 2 and, additionally or alternatively, in various other locations could be connected for example over network 5, to form the server system 12, can also be provided. In particular, for example server system 12 could include, and, additionally or alternatively, connect to various storage devices.

Conveniently, various data exchanges between server 12, and, additionally or alternatively, security enhancement server 13, and, additionally or alternatively, client computer 9 over network 5 could be preformed by applying various encryption techniques, for example by using protocols such as SSL—Secure Socket Layer.

Conveniently, as illustrated in FIG. 2 data 20 stored on server 12 could be accessed from client computer 9 and exchanged in from of data packets 17, containing data in various formats, for example text, graph, image, encrypted image 15, table, etc.

Conveniently, as logically illustrated in FIG. 2 client computer 9 could request access to various data 20 stored on server 12 over network 5, such request could cause server 12 to access the requested data in data storage 20, and, additionally or alternatively, could cause server 12 to package the requested data as data packet 16 containing data in various formats, for example text, graph, image, table, etc., and, additionally or alternatively, could cause server 12 and, additionally or alternatively, security enhancement server 13 to convert all or parts of the data in data packet 16 into their graphical representation plain image 14, and, additionally or alternatively, could cause security enhancement server 13 to convert plain image 14 into encrypted image 15, and, additionally or alternatively, could cause server 12 and, additionally or alternatively, security enhancement server 13 to replace plain image 14 in data packet 16 with encrypted image 15 to form data packet 17 containing encrypted image 15, and, additionally or alternatively, could cause server 12 and, additionally or alternatively, security enhancement server 13 to send data packet 17 over network 5 to client computer 9.

Conveniently, as logically illustrated in FIG. 2, plain image 14 from data packet 16 could be transferred by server 12 to security enhancement server 13 over network 5, then plain image 14 could be converted into encrypted image 15 by security enhancement server 13 for example by replacing plain image pixel data with encrypted pixel data, and then encrypted image 15 could be transferred back to server 12 by security enhancement server 13 over network 5, and then server 12 could convert data packet 16 into data packet 17 by replacing plain image 14 data with encrypted image 15 data.

Conveniently, various transfers of data between computer-based systems (for example server 12, security enhancement server 13, client workstation 1) could be done in a secure manner, for example by encrypting, and, additionally or alternatively, signing exchanged data.

Conveniently, for the purposes of this description, the term converting plain image 14 into encrypted image 15 could refer to any mechanism or technique for transforming or hiding valid data of plain image 14 so that the valid data becomes difficult to view, intercept, process, or modify without proper authorization and thus, appears as invalid data when accessed in an unauthorized manner. Conveniently, conversion techniques may be implemented as software, hardware, circuitry, and, additionally or alternatively, firmware.

Conveniently, as logically illustrated in FIG. 2 client computer 9, could receive data packet 17 from server 12 over network 5, received data packet 17 could include (contain) encrypted image 15 data, client computer 9 then could for example graphically represent received data in data packet 17 as graphical representation image 18 that could include graphical representation of encrypted image 15, client computer 9 then could for example display the image 18 on desktop view 51.

Conveniently, graphical circuitry 58 of client computer 9 could transmit desktop view 51 as a steam of graphical (video) data for example via Digital Visual Interface DVI interface, and, additionally or alternatively, via DisplayPort interface.

Conveniently, for the purposes of this description, it should be understood that references to various acts taken, and, additionally or alternatively, operations performed by client computer 9 could refer to acts taken, and, additionally or alternatively, operations performed by client computer 9 various hardware and, additionally or alternatively, circuitry, and, additionally or alternatively, could refer to acts taken, and, additionally or alternatively, operations performed by various applications running on client computer 9.

Conveniently, as illustrated in FIG. 2 desktop view 51 could be transmitted as stream of graphical data by client's computer 9 graphical circuitry 58, for example through DVI interface and, additionally or alternatively, HDMI interface, then the stream could be captured, and, additionally or alternatively, analyzed, and, additionally or alternatively, processed, and, additionally or alternatively, decrypted by client workstation security enhancement device 10, and then transmitted by client workstation security enhancement device 10 for example through DVI interface to display device 6.

Conveniently, client workstation security enhancement device 10 could be implemented as device, and, additionally or alternatively, system, and, additionally or alternatively, application, and, additionally or alternatively, chip, and, additionally or alternatively, circuit, and, additionally or alternatively, product. For example client workstation security enhancement device 10 could be implemented as part of client computer graphical circuitry 58, and, additionally or alternatively, as part of display device 6 circuitry, and, additionally or alternatively, as device.

Conveniently, data packet 17 received on client computer 9 from server computer 12 could be graphically represented as image 18 by client computer 9 to be displayed, while for example graphical representation 18 could contain full or partial graphical representation of encrypted image 15.

Continently, for example, graphical data from client computer 9 transmitted via for example Digital Visual Interface DVI interface could be captured by client workstation security enhancement device 10, then client workstation security enhancement device 10 could for example process graphical data stream, for example detect and decrypt encrypted images 15 in graphical data stream, then client workstation security enhancement device 10 could transmit processed graphical data stream to monitor device 6, in same or different format, for example in DVI, and, additionally or alternatively, DisplayPort, and, additionally or alternatively, analog VGA format, and, additionally or alternatively, different resolution. For example graphical representation 18 of data packet 17 in captured steam of graphical data form client computer 9 could be substituted (converted) by client workstation security enhancement device 10 into graphical representation data 19 that could differ from graphical representation 18 by replacing all or parts of encrypted image 15 pixel data with decrypted image 14 pixel data.

Conveniently, client workstation security enhancement device 10 could perform the acts of: capturing steam of graphical data from computer 9, buffering captured graphical data, analyzing captured graphical data, processing the captured graphical data, and, additionally or alternatively, transmitting the processed graphical data as stream of graphical (video) data for example via DVI interface to for example display device 6. The act of analyzing captured graphical data could include for example acts of: looking for encrypted images 15, and, additionally or alternatively, data and, additionally or alternatively, instructions embedded in pixel data of captured graphical data stream by for example looking for predetermined patters in pixel data that could indicate that pixel data is part of for example encrypted image 15 and, additionally or alternatively, encrypted image header 29. The act of processing captured graphical data could include the acts of: calculating CRC value for specific slices of detected embedded data and then for example comparing the calculated CRC with embedded in pixel data CRC values where a match could indicate a valid embedded data, then for example in case on encrypted image 15 detection pixel data of the detected encrypted image 15 could be decrypted and encrypted image 15 pixel data is substituted in buffered graphical data stream with decrypted image 14 pixel data.

Conveniently, client workstation security enhancement device 10 could connect to graphical output of computer 9, capture the transmitted graphical stream of computer 9, process the captured graphical data stream for example detect and decrypt encrypted images 15 and substitute encrypted image 15 pixel data with decrypted image 14 in captured graphical data, and transmit the captured and processed graphical data as stream of graphical (video) data stream for example to display device 6 for example in DVI format.

Conveniently, graphical representation 18 of data in data packet 17 displayed by client computer 9, for example on desktop view 51, could be transmitted by client's computer 9 graphical circuitry 58 as graphical desktop view 51 graphical (video) data stream, for example through DVI interface, client workstation security enhancement device 10 could then capture the stream of graphical data from client's computer 9 graphical circuitry 58, process the stream for example by detecting encrypted images 15, decrypting encrypted images 15, replacing (substituting) encrypted image 15 pixel data with decrypted image 14 pixel data and then transmitting the captured and processed stream of graphical data. For example, such stream of graphical data could represent desktop view 51 where graphical representation 18 of data in data packet 17 was substituted (replaced) with graphical representation 19 were encrypted image 15 data substituted (replaced) with decrypted image 14 pixel data performed for example by client workstation security enhancement device 10.

Conveniently, as illustrated in FIG. 2 unauthorized user, through his/hers workstation 3, by applying various hacking techniques could gain access, via network 5 or by other means, to client computer 9 in a manner that could gain unauthorized user access to data packets 17 and, additionally or alternatively, other data accessible via client computer 9 in a manner that unauthorized user 3 could, for example, graphically represent data packet 17 on his/hers computer system 11 and for example would be able to perceive data from data package 17 as graphical image 18 on his/hers display, then in such case unauthorized user 3 would perceive in viewed graphical image 18 graphical representation of encrypted image 15 on his/hers display but would not be able to decrypt the encrypted image 15 to gain access to graphical representation of sensitive data as plain image 14.

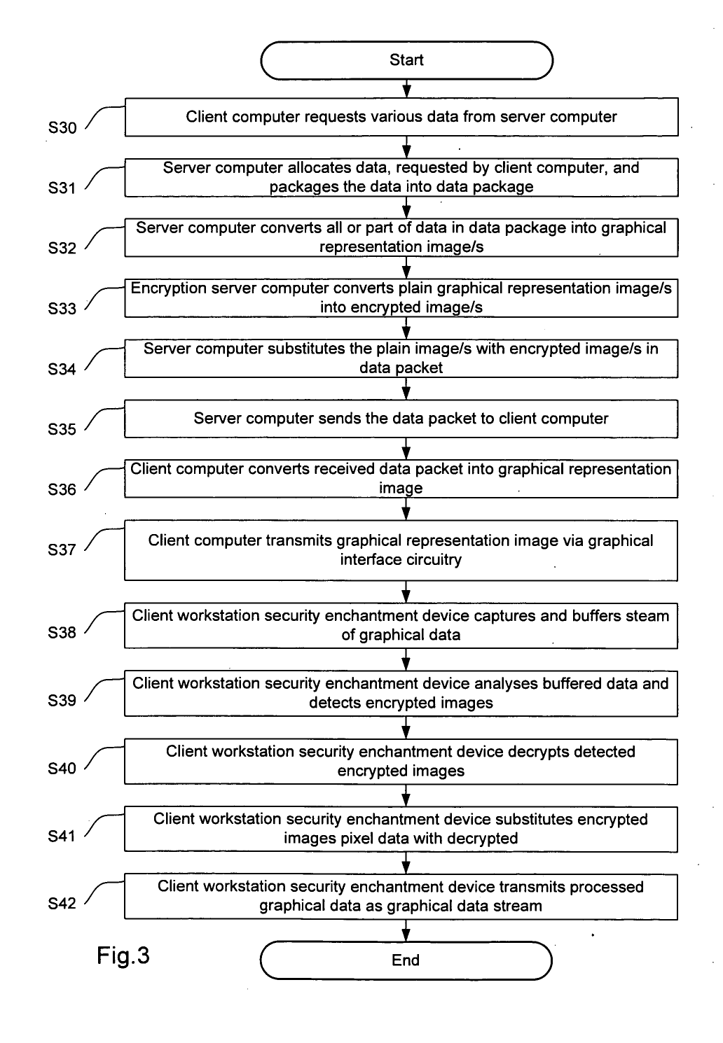

Conveniently, FIG. 3 illustrates an exemplary flow diagram for maintaining secure client computer 9 access to data 20 stored on server computer 12, that could include the acts of: client computer 9 issuing data request to server computer 12 (S30), server computer 12 graphically representing as plain image 14 all or parts of data requested by client computer 9 (S32), security enhancement server 13 converting plain image/s 14 into encrypted image/s 15 (S33), client computer 9 receives data packet 17 that could include encrypted image/s 15 (S35), client computer 9 graphically represents data in data packet 17 as graphical representation 18 where such graphical representation 18 could include encrypted image/s 15 graphical representation (S36), graphical representation 18 could be displayed as part of desktop view 51 (S37), client workstation security enhancement device 10 could capture and buffer graphical (video) data stream from computer 9 (S38), client workstation security enhancement device 10 could detect embedded encrypted images 15, and, additionally or alternatively, other various data, and, additionally or alternatively, instructions embedded in captured graphical data stream (S39), client workstation security enhancement device 10 could process the captured graphical data for example substitute detected encrypted image/s 15 with decrypted plain image 14 pixel data in captured graphical data stream by applying various decryption techniques (S40), converting graphical representation 18 containing encrypted image 15 view into graphical representation 19 containing plain image 15 view in captured graphical data stream, for example by substituting pixel data of encrypted image 15 with decrypted image 14 pixel data (S41), client workstation security enhancement device 10 transmits processed graphical data stream for example to display device 6 (S42).

Conveniently, in operation, the stream of graphical data from client computer 9 representing video image 51 could be captured, analyzed, processed and transmitted to the display device 6 by circuitry, and, additionally or alternatively, application software of client workstation security enhancement device 10. For example, the client workstation security enhancement device 10 could include software and, additionally or alternatively, hardware for capturing, processing, and, additionally or alternatively, transmitting graphical data stream.

Conveniently, client workstation security enhancement device 10 may be coupled to the video graphics circuitry 58 of client computer 9, and, additionally or alternatively, client workstation security enhancement device 10 may be implemented as part of video graphics circuitry 58 of client computer 9, and, additionally or alternatively, client workstation security enhancement device 10 may be implemented as part of display device 6 circuitry, and, additionally or alternatively, client workstation security enhancement device 10 may be implemented as system, application and, additionally or alternatively, method.

Conveniently, as illustrated in FIG. 3, at first client computer 9 could issue a data request from server 12 (S30), for example over network 5. Server 12 could then processes client computer 9 request that could lead to allocating requested, by client computer 9, data in various data 20 storages accessible from server 12, then server 12 could convert allocated data into data package 16 that could include all or parts of requested data by client computer 9 (S31), then server 12 could convert all or parts of data in data package 16 that could be in various forms for example text, graph, etc., into graphical representation plain image 14 (S32), then server 12 could send plain image 14 to security enhancement server 13, for example via network 5 in a secure manner, then security enhancement server 13 could convert received plain image 14 into encrypted image 15 by applying various encryption techniques, for example, by replacing pixel data in image 14 with, encrypted by Advanced Encryption Standard AES, pixel data, then security enhancement server 13 could send encrypted image 15 back to server 12 (S33), then server 12 could replace plain image 14 in data packet 16 with received encrypted image 15 to form data packet 17 (S34), then server computer 12 could send data packet 17 to client computer 9, for example via network 5 (S35), then client computer 9 could graphically represent all or part of received data in data packet 17 as graphical representation image 18 and for example could display such image 18 fully and, additionally or alternatively, partially on desktop view 51 (S36), then client computer 9 could transmit desktop view 51 image that could include graphical representation 18 image in various formats, for example via graphical interface Digital Visual Interface DVI, then such steam of graphical data (for example in DVI format) could be captured by client workstation security enhancement device 10 (S37), then client workstation security enhancement device 10 could be buffering the captured graphical data stream that could include graphical representation 18 from client computer 9 (S38), then client workstation security enhancement device 10 could be analyzing the buffered steam of graphical data, for example by looking for encrypted images in buffered data stream (S39), then client workstation security enhancement device 10 could be processing the buffered stream of graphical data, for example by decrypting encrypted image 15 pixel data (S40), then client workstation security enhancement device 10 could be substituting encrypted image 15 pixel data with decrypted image pixel data 14 in buffered stream of graphical data (S41), then client workstation security enhancement device 10 could be transmitting the processed stream of graphical data that could include graphical representation image 19, for example in DVI format, to display device 6 (S42).

Conveniently, client workstation security enhancement device 10 could buffer, analyze, and, additionally or alternatively, process captured graphical data stream in slices of data, for example a slice could include pixel data of one or more rows of transmitted by client computer 9 for example desktop view graphical image 51, and, additionally or alternatively, could include pixel data of one or more frames (full desktop view image 51 pixel data) of transmitted by client computer 9 for example desktop view graphical image 51.

Conveniently, client workstation security enhancement device 10 could apply various techniques and, additionally or alternatively, methods to detect, analyze and, additionally or alternatively, decrypt encrypted images 15 into decrypted images 14 (S40), for example by calculating and checking CRC of the pixel data, and, additionally or alternatively, by decrypting encrypted pixel data in image 15 with for example Advanced Encryption Standard AES.

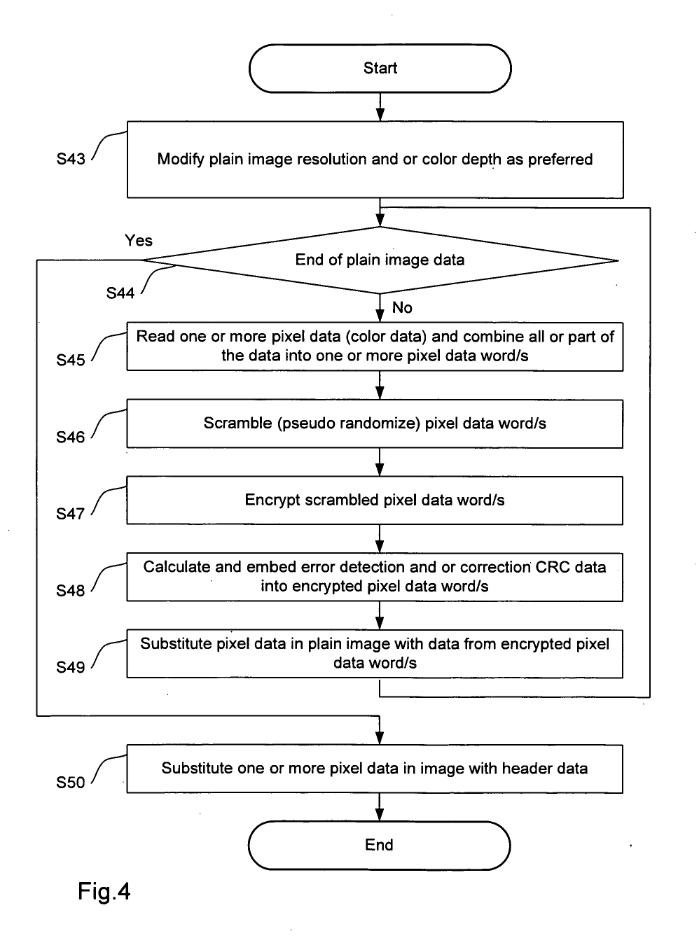

Conveniently, FIG. 4 illustrates exemplary flow diagram of plain image 14 conversion into encrypted image 15 by for example performing various pixel data conversions, and, additionally or alternatively, modifications, and, additionally or alternatively, encryption, and, additionally or alternatively, additions of header data as embedded data in pixel data, and, additionally or alternatively, additions of error correction and, additionally or alternatively, detection data embedded into pixel data.

Conveniently, as illustrated in FIG. 4 at first, plain image 14 various parameters could be modified and, additionally or alternatively, changed, for example, image width and, additionally or alternatively, height in pixels and, additionally or alternatively, pixel color depth could be modified by server 12, and, additionally or alternatively, by security enhancement server 13 (S43), then for example color data of one or more pixels from plain image 14 could be combined into slices of one or more pixel data words of various lengths by taking all or parts of the pixels color data (S45), then for example various data scrambling techniques could be applied to all or parts of the combined pixel data words, for example to pseudo randomize data in pixel data words that for example could have been sourced from plain image 14 where a long sequence of same or similar pixel data could be present, and, additionally or alternatively, to prevent pattern detection in encrypted image 15 (S46), then for example scrambled pixel data words could be encrypted by applying various encryption techniques, for example Advanced Encryption Standard AES, to produce a ciphered pixel data words (S47), then for example error detection and, additionally or alternatively, correction CRC data could be added to the ciphered pixel data words, for example error detection and, additionally or alternatively, correction data bits could be calculated by performing XOR operation between various slices (sets) of data from ciphered pixel data words (S48), then for example plain image 14 pixel data could be substituted (replaced) with data from ciphered pixel data words and, additionally or alternatively, error detection and, additionally or alternatively, correction CRC data bits (S49), in similar manner all or part of pixel data of plain image 14 could be processed one slice pixel data word at a time to form encrypted image 15 (S44), then header data 29 could be embedded in pixel data of the encrypted image 15 for example by substituting one or more pixel data, and, additionally or alternatively, parts of pixel data of encrypted image 15 with header data 29 (S50).

Conveniently, embedded in encrypted image 15 header data 29 could include, width and, additionally or alternatively, height of image in pixels, and, additionally or alternatively, header data 29 could include unique identification value that could function as pointer to key used for encryption of the image, and, additionally or alternatively, header data 29 could include seed value applied to scramble the plain image 14 pixel data, and, additionally or alternatively, header data 29 could include various data and, additionally or alternatively, commands (that could be executed, and, additionally or alternatively, processed for example by client workstation security enhancement device 10), and, additionally or alternatively, header data 29 could include various header error detection and, additionally or alternatively, correction data, and, additionally or alternatively, header data 29 could include various data patterns that could be used by client workstation security enhancement device 10 to detect encrypted images 15 in captured graphical data streams.

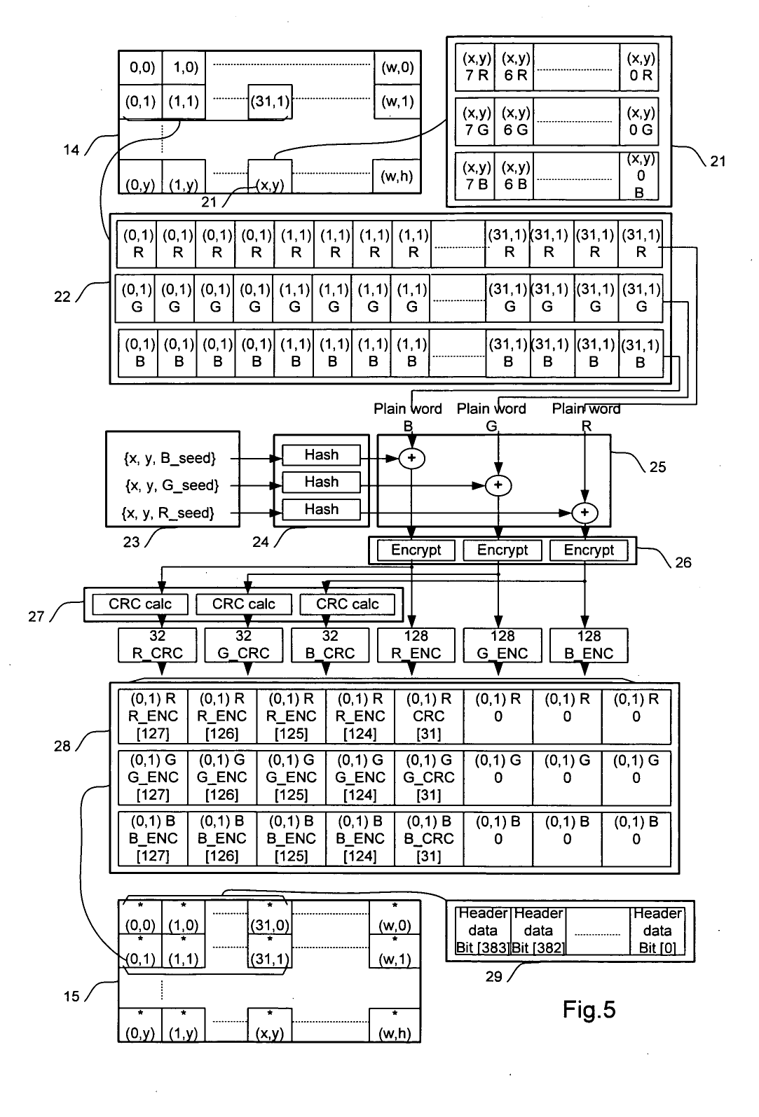

Conveniently, FIG. 5 logically illustrates an exemplary schematic flow of plain image 14 conversion into encrypted image 15.

Conveniently, as logically illustrated in FIG. 5 for example diagrammatic representation of pixel data of plain image 14 could be represented by matrix of pixel data with dimensions of “W, H” where “W” could represent width and “H” could represent height of pain image 14 in pixels, for example for ease of conversion “W” could be a multiple of thirty two. Conveniently, each pixel 21 in plain image 14 could be represented by three colors; RED, GREEN and BLUE and for example each color could be represented by eight bits. Conveniently, data representing one or more consecutive in a row pixels from plain image 14 could be applied to form one or more pixel data representing plain pixel data word/s 22, such plain data word/s 22 could represent relevant pixel data fully or partially for example by taking only top four bits of color data from each pixel to form the plain data word/s 22.

Conveniently, as logically illustrated in FIG. 5, plain image 14 pixel data could be sliced into sets of thirty two consecutive in a row pixels where each pixel could be represented by three colors; red, green and blue, where each color could be represented by eight bits, and each such slice of pixel data could be processed separately. Conveniently, four most significant bits of color of thirty two consecutive in a row pixels of plain image 14 could be applied to form three, each one hundred twenty eight bit long, plain words 22 per each of the three colors respectively; red, green and blue plain word 22. However, for example, the lower four bits of pixel color data may be truncated, rounded, and, additionally or alternatively, dropped, for example to reduce the amount of graphical data that is processed, and, additionally or alternatively, transmitted, yet it should be noted that these lower bits may be utilized if more color accuracy is desired. For example, the red color plain word, one hundred twenty eight bit long, of the three plain words 22 could be assembled from pixel data bits of the thirty two consecutive in a row pixels in the next exemplary manner: red pixel data word={“seventh bit of red color of first pixel”, sixth bit of red color of first pixel”, “fifth bit of red color of first pixel”, “fourth bit of red color of first pixel”, “seventh bit of red color of second pixel”, sixth bit of red color of second pixel”, “fifth bit of red color of second pixel”, “fourth bit of red color of second pixel”, “seventh bit of red color of last pixel”, sixth bit of red color of last pixel”, “fifth bit of red color of last pixel”, “fourth bit of red color of last pixel”}.

Conveniently, as logically illustrated in FIG. 5, three, one hundred twenty eight bit, plain scramble words could be calculated by applying various hash 24 techniques, for example SHA-1 or modification algorithm of SHA-1, to a seed word 23. For example seed word 23 could include values of “X”, and, additionally or alternatively, “Y”, where “X” and “Y” could represent coordinates of starting (first) pixel of the thirty two pixels in the slice, and, additionally or alternatively, seed word 23 could include various additional seed values (for example BLUE_SEED, and, additionally or alternatively, RED_SEED, and, additionally or alternatively, GREEN_SEED) that could vary from one data scramble word to another, and, additionally or alternatively, from one image 14 to another image 14, and, additionally or alternatively, could be unique per each new image 14, and, additionally or alternatively, in respect to key applied during encryption 26.

Conveniently, as logically illustrated in FIG. 5, then the three plain words 22 could be XORed with the three scramble words produced by the hash 24 operation accordantly, to form three one hundred twenty eight bit words to be encrypted for example by Advanced Encryption Standard AES, to produce three ciphered words of one hundred twenty eight bit each respectively; R_ENC, G_ENC and B_ENC.

Conveniently, then three thirty two bit each error detection CRC words could be calculated; R_CRC, G_CRC, and B_CRC. For example, R_CRC, G_CRC, and B_CRC could be calculated 27 from three cipher words; R_ENC, G_ENC and B_ENC by applying various techniques, and for example the three error detection CRC words; R_CRC, G_CRC, and, additionally or alternatively, B_CRC could be latter applied for error detection in, and, additionally or alternatively, validity checks of cipher words R_ENC, G_ENC and B_ENC. For example R_CRC, G_CRC, and B_CRC could be calculated by performing XOR between various sets of bits of R_ENC, G_ENC and B_ENC, for example by the following calculation; R_CRC[31]={(R_ENC[127]) XOR (R_ENC[123]) XOR (R_ENC[119]) XOR (R_ENC[115])}; R_CRC[30]={(R_ENC[126]) XOR (R_ENC[122]) XOR (R_ENC[118]) XOR (R_ENC[114])}; . . . R_CRC[27]={(R_ENC[111]) XOR (R_ENC[107]) XOR (R_ENC[103]) XOR (R_ENC[99])}; . . . etc.}.

Conveniently, as logically illustrated in FIG. 5, ciphered words, and, additionally or alternatively, error detection CRC words; R_ENC, G_ENC, B_ENC, R_CRC, G_CRC and B_CRC, could be embedded in thirty two pixels as pixel color data 28 to form the pixels data of encrypted image 15. Conveniently, eight bits of red color data of a pixel 28 of encrypted image 15 could be combined by taking four bits from R_ENC cipher word and one bit from R_CRC CRC word to form five most significant bits of red color data, and then three zero bits added to form eight bits of red color data of a pixel 28. For example, by taking four bits of R_ENC data word (R_ENC[127:123]) as most significant bits of red color of pixel 28 and adding one bit from R_CRC data word (R_CRC[31]) and adding three zero bits to form pixel 28 red color data {R_ENC[127:123], R_CRC[31], 000}, such pixel 28 could be positioned as first related to other thirty one pixels that could be formed from the R_ENC, G_ENC, B_ENC, R_CRC, G_CRC and B_CRC words respectively. Conveniently, green and blue pixel color data of pixel data 28 of encrypted image 15 could be combined in a similar manner from G_ENC, G_CRC and B_ENC, B_CRC data words respectively. Conveniently, pixel data of thirty two pixels of encrypted image 15 could be combined from R_ENC, G_ENC, B_ENC, R_CRC, G_CRC and B_CRC data in a similar manner. Conveniently, the ciphered (encrypted) pixels data 28 could substitute pixel data in plain image 14 to form encrypted image 15.

Conveniently, header data 29 could be embedded in pixel data of encrypted image 15, for example by substituting one or more pixel data, and, additionally or alternatively, parts of pixel data, with header data 29.

Conveniently, as logically illustrated in FIG. 5, pixel data of thirty two consecutive in a row pixels in top left corner of encrypted image 15 could be substituted (replaced) with header data 29, for example each of the thirty two pixels could represent twelve bits of header data 29, Conveniently, for example such thirty two pixels could represent three hundred and eighty four bits of header data 29 respectively. For example, header data 29 could include various data, and, additionally or alternatively, commands, for example header data 29 could include image width in pixels, and, additionally or alternatively, image height in pixels, and, additionally or alternatively, unique key identification of key applied during pixel data encryption, and, additionally or alternatively, seed value applied during scramble words generation 24, and, additionally or alternatively, data that could be used for error detection and, additionally or alternatively, error correction of header data 29, and, additionally or alternatively, unique identification of client workstation security enhancement device 10 intended to decrypt the encrypted image 15, and, additionally or alternatively, various predetermined data patterns that could be used for example by client workstation security enhancement device 10 to detect encrypted images 15 and, additionally or alternatively, header data 29 in stream of graphical data, for example steam of graphical data could be in DVI format.

Conveniently, by processing all or part of pixel data of plain image 14, for example as illustrated in FIG. 5, an encrypted image 15 could be generated. Accordantly, for example all or parts of pixel data of image 14 could be encrypted in the similar manner.

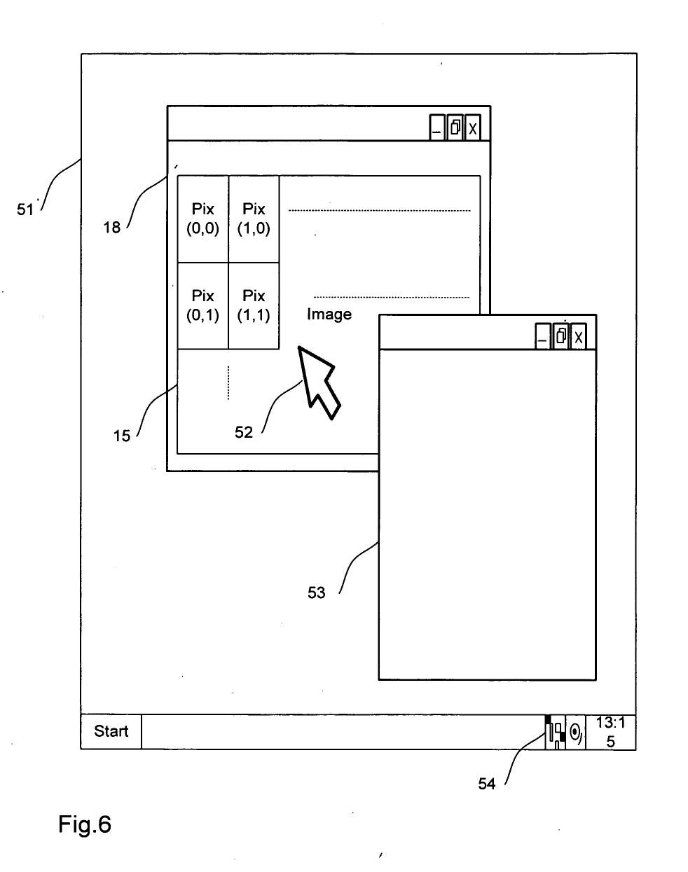

Conveniently, FIG. 6 illustrates exemplary desktop view 51 as could be generated by computer 9 of client workstation 1, displaying all or parts of encrypted image 15.

Conveniently, as illustrated in FIG. 6 desktop view 51 generated on client computer 9 could include full or partial view of encrypted image 15, for example as image 15 displayed in window 18 for example as part of graphical representation of data in data packet 17, and, additionally or alternatively, could include various other windows 53, and, additionally or alternatively, could include cursor graphical representation data 52, and, additionally or alternatively, could include various icons for example in notification area. For example, the encrypted image 15, for example displayed in window 18, could be fully and, additionally or alternatively, partially concealed on desktop view 51 by other windows 53, and, additionally or alternatively, partially concealed by cursor graphical representation data 52.

Conveniently, desktop view 51 of client computer 9 running windows based operating system could display graphical representation of data in data packet 17 that could include graphical representation of all or parts of encrypted image 15 pixels, for example in window 18. Typically, for example displayed image 15 in a window 18 on desktop view 51 could be fully, and, additionally or alternatively, partially concealed for example by cursor graphical representation 52 data, and, additionally or alternatively, by various windows 53, and, additionally or alternatively, by window 18 movement outside of desktop 51 view range. Conveniently, various data and, additionally or alternatively, instructions in plain, and, additionally or alternatively, encrypted format could be embedded in pixel data of icon 54, for example icon 54 could be displayed in notification area. Conveniently, desktop view 51 transmitted for example as stream of graphical data by client computer 9, for example in DVI format, could be captured by client workstation security enhancement device 10, processed and data and, additionally or alternatively, instructions that could be embedded in icon 54 could be applied (for example instructions could be executed) by client workstation security enhancement device 10 in various ways.

Conveniently, all or parts of pixel data of encrypted image 15 as is and, additionally or alternatively, modified could be graphically represented as part of display view 51.

Conveniently, encrypted image 15 could be displayed as is in desktop view 51 and, additionally or alternatively, could be modified, for example by adjusting on client computer 9 displayed view 51 image brightness and, additionally or alternatively, contrast that could result in displaying encrypted image 15 with modifications to pixel data that could result in errors appearing in embedded data. Conveniently, various reference pixel data and, additionally or alternatively, instructions could be embedded in pixel data of encrypted image 15 and, additionally or alternatively, icon 54 to be applied for example by workstation security enhancement device 10 for correction of the errors. Conveniently, pixel data of encrypted image 15 could be modified to compensate the brightness and, additionally or alternatively, contrast and, additionally or alternatively, other changes that could be applied to images displayed in desktop view 51.

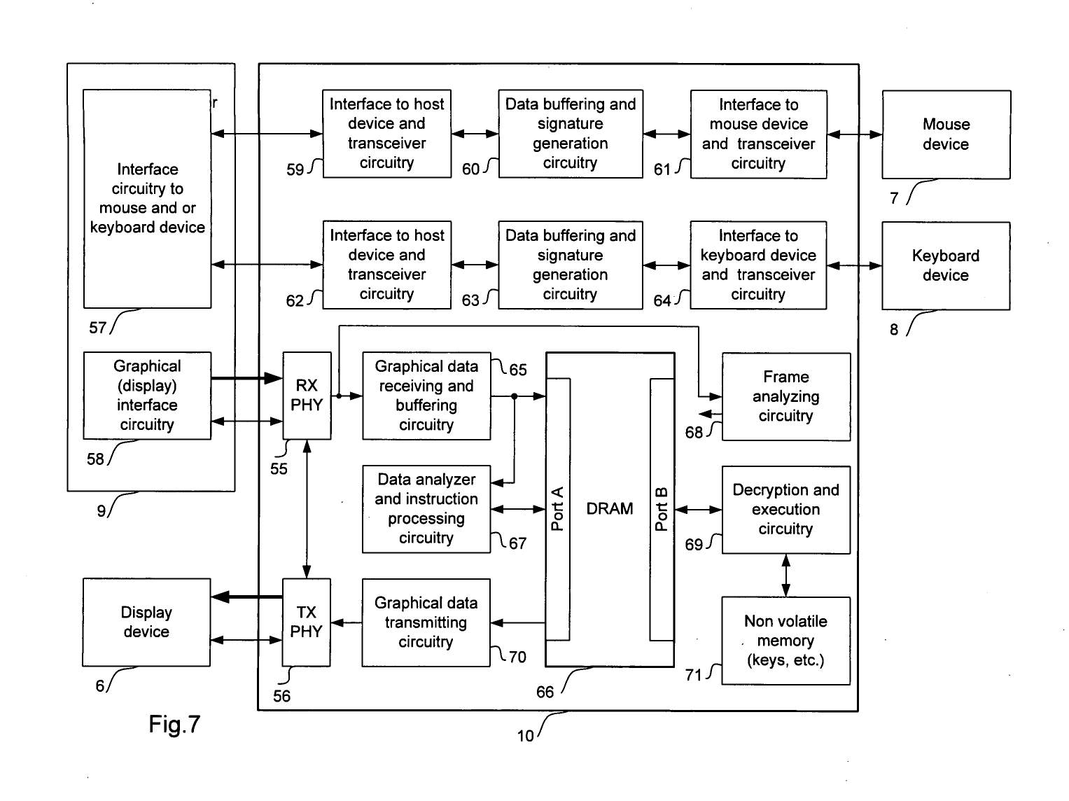

FIG. 7 illustrates exemplary block diagram of client workstation security enhancement device 10.

Conveniently, client workstation security enhancement device 10 could be implemented as circuit, chip, device, application, firmware, and, additionally or alternatively, system.

Conveniently, as illustrated in FIG. 7 mouse device 7 could be connected to client workstation security enhancement device 10 through interface and transceiver circuitry 61, then Conveniently, data from mouse device 7 could be buffered and processed for example by signature adding by data buffering and signature generation circuitry 60, then the processed data with added signature data could be transmitted to host computer 9 mouse interface circuitry 57 via interface to host and transceiver circuitry 59 of client workstation security enhancement device 10.

Conveniently, as illustrated in FIG. 7 keyboard device 8 could be connected to client workstation security enhancement device 10 through interface and transceiver circuitry 64, then Conveniently, data from keyboard device 8 could be buffered and processed for example by signature adding by data buffering and signature generation circuitry 63, then the processed data with added signature data could be transmitted to host computer 9 keyboard interface circuitry 57 via interface to host and transceiver circuitry 62 of client workstation security enhancement device 10.

Conveniently, as illustrated in FIG. 7 client workstation security enhancement device 10 could link to graphical interface circuitry 58 of client computer 9 via RX PHY circuitry 55 that could capture graphical data stream transmitted by graphical interface circuitry 58, for example graphical data stream could be in DVI format.

Conveniently, as illustrated in FIG. 7 client workstation security enhancement device 10 could link to display device 6 via TX PHY circuitry 56 that could transmit captured and processed graphical data stream by client workstation security enhancement device 10 to display device 6, for example in DVI format.

Conveniently, as illustrated in FIG. 7 client workstation security enhancement device 10 could include graphical data receiving and buffering circuitry 65 that could receive, from RX PHY circuitry 55, the captured graphical data stream and buffer the graphical data stream into memory 66, that for example could be a dual port RAM 66, that for example could also be referred to as DPRAM 66. Conveniently, data could be buffered into logically defined data area in memory 66.

Conveniently, as illustrated in FIG. 7 client workstation security enhancement device 10 could include data analyzer and instruction processing circuitry 67 that could monitor the buffered graphical data stream by graphical data receiving and buffering circuitry 65, for example to detect various embedded encrypted images 15 and, additionally or alternatively, icons 54 and, additionally or alternatively, various other embedded data and, additionally or alternatively, instructions in graphical data stream. Conveniently, data analyzer and instruction processing circuitry 67 upon detection of embedded data in graphical data stream could generate an instruction and store it in memory 66, for example such instruction could be then read and executed by decryption and execution circuitry 69. Conveniently, instructions could be buffered into logically defined instruction area in memory 66.

Conveniently, data analyzer and instruction processing circuitry 67 could detect encrypted image 15 in buffered graphical data stream, analyze encrypted image 15 header 29 and then could generate an instruction and store it in memory 66, such instruction could include relative address pointer to location in memory 66 of encrypted image 15 in buffered data, and, additionally or alternatively, could include relative address pointer to key that could be applied for encrypted image 15 decryption, and, additionally or alternatively, could include seed value that could be applied for hash 24 calculation that could be performed 24 during decryption of encrypted image 15.

Conveniently, as illustrated in FIG. 7 client workstation security enhancement device 10 could include decryption and execution circuitry 69 that could access instructions stored in memory 66, for example instructions that could have been generated by data analyzer and instruction processing circuitry 67, and execute such instructions. For example, decryption and execution circuitry 69 during execution of an instruction could read pixel data of encrypted image 15, buffered in memory 66, decrypt it and substitute the encrypted pixel data with decrypted pixel data in memory 66.

Conveniently, decryption and execution circuitry 69 could calculate the CRC values of data buffered in memory 66, for example of slice of data of encrypted image 15 pixel data to, for example, assess if the data is valid encrypted image 15 pixel data or for example other graphical data that overlaid the encrypted image 15 pixel data in desktop view 51, for example graphical data of cursor 52, and, additionally or alternatively, window 53 could have overlaid the encrypted image 15 in desktop view 51. For example, the CRC values may be calculated using various mathematical techniques, these calculated CRC values may be compared with embedded in pixel data of encrypted image 15 CRC values, if these CRC values mach and detected as valid, the decryption and execution circuitry 69 could for example decrypt pixel data of encrypted image 15 buffered in memory 66 and substitute the encrypted image 15 pixel data with decrypted pixel data in memory 66 to form full or partial graphical representation of plain image 14.

Conveniently, in one embodiment of the invention the memory array 66 of client workstation security enhancement device 10, for example to reduce the number of cells in memory 66, could store only single row of pixel data of desktop view 51 at a time, in such case, for example only a single row of pixel data of encrypted image 15 that could be displayed as part of desktop view 51 could be stored in memory 66 at a time.

Therefore, for example decryption and execution circuitry 69 could execute instruction, that for example was generated by data analyzer and instruction processing circuitry 67 for example as a result of encrypted image 15 detection in buffered graphical data stream, during execution of such instruction, decryption and execution circuitry 69, could process a single row of encrypted image 15 pixel data and then update (modify) the executed instruction to generate instruction for decryption of next row of encrypted image 15 pixel data, such updated (modified) instruction could be then executed by decryption and execution circuitry 69 during next row, of graphical data stream, processing. For example during execution of such instruction on last row of encrypted image 15 decryption and execution circuitry 69 may erase (disable) the executed instruction. For example, data analyzer and instruction processing circuitry 67 could modify and, additionally or alternatively, overwrite (overlay) instruction in memory 66, if another encrypted image 15 detected as overlaying, the already detected encrypted image 15, in graphical data stream.

Conveniently, as illustrated in FIG. 7 client workstation security enhancement device 10 could include non volatile memory 71 that could for example be integrated as part of client workstation security enhancement device 10 circuitry, and, additionally or alternatively, non volatile memory 71 circuitry could be implemented as die, chip, device and, additionally or alternatively, system, and, additionally or alternatively, combination of devices.

Conveniently, as illustrated in FIG. 7 non volatile memory 71 circuitry could be coupled with decryption and execution circuitry 69, for example non volatile memory 71 could be coupled in a manner that enables decryption and execution circuitry 69 to read, and, additionally or alternatively, write data in non volatile memory 71. For example, non volatile memory 71 could store keys that could be applied for encrypted image 15 decryption, yet another example, various areas of non volatile memory 71 could be locked, during operation and, additionally or alternatively, personalization, for writing by decryption and execution circuitry 69 or by other means.

Conveniently, as illustrated in FIG. 7 client workstation security enhancement device 10 could include graphical data transmitting circuitry 70 that could read buffered, and, additionally or alternatively, processed graphical steam data from memory 66 and transmit it via graphical transmit interface circuitry TX PHY.

Conveniently, as illustrated in FIG. 7 client workstation security enhancement device 10 could include TX PHY 56 that could interface with various graphical devices, for example with display device 6, and transmit stream of graphical data, for example in DVI format.

Conveniently, RX PHY 55, and, additionally or alternatively, TX PHY 56 could receive and transmit data accordantly, in various formats, for example in Digital Visual Interface DVI format, and, additionally or alternatively, in VGA analog format.

Conveniently, interface of client workstation security enhancement device 10 to mouse device 7, and, additionally or alternatively, keyboard device 8, and, additionally or alternatively, host computer 9 could include for example PS/2, and, additionally or alternatively, USB interfaces.

Continently, for example data between mouse device 7, and, additionally or alternatively, keyboard device 8 could be exchanged with personal computer 9 via client workstation security enhancement device 10 as is, and, additionally or alternatively, data could be modified by client workstation security enhancement device 10 in various ways, for example exchanged data could be modified by client workstation security enhancement device 10 by addition, modification, and, additionally or alternatively, substitution of exchanged data.

Conveniently, one or more rows, and, additionally or alternatively, one or more frames of captured by client workstation security enhancement device 10 pixel data, for example representing desktop view 51, could be stored in memory array 66 at a time, before for example pixel data overrun could occur, for example, memory array 66 storage depth for captured data could be only enough to store one or more rows, and, additionally or alternatively, one or more frames of pixel data of captured graphical data accordantly. Conveniently, in one embodiment of the invention, memory array 66 depth for storing captured graphical data could be six thousand one hundred forty four bit deep, for example one row of two thousand forty eight pixels, represented by twenty four bits of color data per each pixel, could be stored at a time in memory array 66 of such depth before data overrun could occur.

Conveniently, sometimes large amounts of graphical data associated with video image 51 could be problematic to capture, and, additionally or alternatively, process, and, additionally or alternatively, transmit in real-time. Accordingly, some embodiments of the present technique could divide the capture of graphical data into slices of data. The slices of data captured from streaming graphical data in real-time could synchronously be stored in memory 66. Once a slice has been captured, for example a non-timing dependent or asynchronous process could process the captured graphical data, as the timing dependent process could resume and capture the next available slice of streaming graphical data while transmitting the current one. As a result, the timing dependent process of capturing graphical data stream from computer 9 and presenting the graphical data to the display device 6 is separated from the non-timing dependent processing of the graphical data, for example by decryption and execution circuitry 69.

Conveniently, memory array 66 could be implemented as circuitry, and, additionally or alternatively, as circuitry system of several memory arrays of various types, and, additionally or alternatively, as chip and, additionally or alternatively, as device and, additionally or alternatively, as system. For example memory array 66 could be implemented as circuitry of single port RAMs, and, additionally or alternatively, circuitry of dual port RAM, and, additionally or alternatively, several types and, additionally or alternatively, sizes of RAM circuitries interconnected by various circuitry to form memory array 66.

Conveniently, specific instructions that could be executed by decryption and execution circuitry 69, could result for example in addition, and, additionally or alternatively, removal, and, additionally or alternatively, substitution of keys stored in keys area in non volatile memory array 71 with, for example keys received as embedded data in pixel data, in a secure manner, for example as part of icon 54 pixel data displayed as part on desktop view 51.

Conveniently, keys, and, additionally or alternatively, various data stored in non volatile memory 71 could be valid without time limit or could be valid for various periods of time, valid time periods per key could be preprogrammed, and, additionally or alternatively, dynamically changed via for example embedded instructions in transmitted pixel data for example of icon 54.

Conveniently, as illustrated in FIG. 7 client workstation security enhancement device 10 could include frame analyzing circuitry 68 that could be monitoring captured graphical data, and, additionally or alternatively, could be detecting various parameters of captured graphical data, and, additionally or alternatively, could be providing information about various parameters of captured graphical data for example to circuitries of client workstation security enhancement device 10. For example, in case that graphical data stream is received in DVI format, frame analyzing circuitry 68 could for example detect such parameters as width and height of frame in pixels, and, additionally or alternatively, could detect waveform and timing of vertical synchronization VSYNC and horizontal synchronization HSYNC signals. For example frame analyzing circuitry 68 could also detect current horizontal position, and, additionally or alternatively, current vertical position, of a captured pixel.

Conveniently, client workstation security enhancement device 10 could be powered by various client computer 9 interfaces, for example from 5V of DVI interface.

Conveniently, graphical data receiving and buffering circuitry 65, data analyzer and instruction processing circuitry 67, graphical data transmitting circuitry 70, frame parameters analyzing circuitry 68 and port A of DPRAM memory 66 could operate in one clock domain, while decryption and execution circuitry 69, non volatile memory 71 circuitry and port B of DPRAM memory 66 could operate in another clock domain, Conveniently, for example the two clock domains could be of different frequency, and, additionally or alternatively, asynchronous to each other. Conveniently, memory 66 could be a true dual port RAM memory DPRAM 66.

Conveniently, memory array 66 could be logically divided into pixel data area and instruction and data area, while depth of pixel data area for example could be enough to store data of one or more rows of pixels, while instruction area could store all or parts of embedded instructions and data that could be embedded in a single frame. Conveniently, in some embodiments of the invention memory array 66 pixel data area depth enables to store only one row of pixel data and every new row stored overwrites the previous row pixel data.

Conveniently, to data (that could represent various keystrokes) received by interface circuitry 64 from keyboard device 8, data representing various sequence of keystrokes could be added, to serve for example as a signature, the added keystrokes sequence, could be generated for example by signature circuitry 63, and then the combined sequence of keystrokes (keyboard device 8 keystroke data and added signature keystroke data) transmitted, for example to client computer 9, via interface circuitry 62. For example to received key stroke data from keyboard device 8, that for example could represent keystroke of letter “a”, a signature of {2*M} emulated keystroke symbols could be added by signature circuitry 63, so that the received data representing for example keystroke “a” (from keyboard device 8) could be transformed into generated keystroke sequence of for example {“a”, “signature symbol[M]”, “backspace”, “signature symbol[M1]”, “backspace”, . . . “signature symbol[0]”, “backspace”}, that could then be transmitted for example to client computer 9. For example, such sequence {“a”, “signature symbol[M]”, “backspace”, “signature symbol[M−1]”, “backspace”, . . . “signature symbol[0]”, “backspace”} if received for example by text editor application on client computer 9 could result in typing only letter “a” in a text window, since following signature symbols “signature symbol[M]” could be typed and then erased by the text editor since followed by “backspace” keystroke symbol.

Yet, Conveniently, such keystroke with signature sequence data {“a”, “signature symbol[M]”, “backspace”, “signature symbol[M−1]”, “backspace”, . . . “signature symbol[0]”, “backspace”} could be transmitted via network 5 to server 12, and, additionally or alternatively, security enhancement server 13 and the signature keystroke sequence {signature symbols[M:0]} could be applied to validate that the keystroke was actually “a” and, additionally or alternatively, that this signature was generated by client workstation security enhancement device 10 of client workstation 1 and not for example emulated by malicious hacker. For example, such signature {signature symbols[M:0]} could include time reference data of when the keystroke and the signature was made, for example to prevent malicious hackers from buffering signed keystrokes and then for example resending them as valid signed keystrokes at different order and, additionally or alternatively, time. For example, such emulated keystroke data signature data {signature symbols[M:0]} could be analyzed by server 12 and, additionally or alternatively, security enhancement server 13 to validate that the keystroke was physically made on keyboard device 8 connected to specific client workstation security enhancement device 10 and for example not emulated on client computer 9 by malicious user (hacker).

Conveniently, to data (that could represent various clicks and, additionally or alternatively, movements) received via interface circuitry 61 from mouse device 7, data representing various sequence of mouse movements could be added, to serve for example as a signature, the added movement data sequence could be generated for example by signature generation circuitry 60, and then the combined sequence of mouse device 7 movement and, additionally or alternatively, clicks data and signature movement sequence data generated by circuitry 60 could be transmitted to client computer 9 via interface circuitry 59. For example to received movements and, additionally or alternatively, clicks data from mouse device 7, for example that could represent left button mouse click, a signature of {N} emulated mouse movements could be added by signature circuitry 60, so that the received data (from mouse device 7) could be transformed into generated mouse movement and, additionally or alternatively, clicks data sequence of for example {“left click”, “signature movement[N], signature movement[N−1], . . . signature movement[0]}, that could then for example be transmitted to client computer 9. For example, such sequence {“left click”, “signature movement[N], signature movement[N−1], . . . signature movement[0]} received by client computer 9 could result in {N} cursor movements on computer 9 desktop view 51, yet such signature movements {signature movement[N:0]} could include equal value of right movements to left movements and equal value of up movements to down movements, so for example if received by operating system of client computer 9 could result in cursor moving left, right, up and, additionally or alternatively, down slightly and then returning to the position held before the signature movements applied.

Yet, Conveniently, such mouse movement and, additionally or alternatively, click sequence and signature sequence data {“left click”, “signature movement[N], signature movement[N−1], . . . signature movement[0]} could be transmitted via network 5 to server 12, and, additionally or alternatively, security enhancement server 13 and the signature movement sequence {signature movements[N:0]} could be analyzed to validate the mouse data for example the “left click” input data, in other words such signature movement sequence {signature movements[N:0]} could be applied to assess if the “left click” originated at mouse device 7 of client workstation 1 or could have been emulated for example by malicious users.

Conveniently, such emulated mouse data movement signature data {signature movements [N:0]} could be analyzed by server 12 and, additionally or alternatively, security enhancement server 13 to validate that the mouse device data was physically made through mouse device 7 connected to specific client workstation security enhancement device 10 and not for example emulated on client computer 9 by malicious user (hacker) and, additionally or alternatively, valid mouse data with signature data was not buffered by malicious user (hacker), and, additionally or alternatively, mouse data sequence was modified for example by changing order of mouse movements and, additionally or alternatively, clicks data and, additionally or alternatively, coping mouse data to form new and, additionally or alternatively, modified mouse data sequences, that could be perceived as valid mouse device 7 data from client workstation 1.

Conveniently, client workstation security enhancement device 10 could have a unique identification value that could be applied and, additionally or alternatively, embedded in encrypted images 15 and, additionally or alternatively, other embedded data to indicate to a specific client workstation security enhancement device 10 that the data is intended to a specific client workstation security enhancement device 10 of unique identification value that could match or not the unique identification value of the specific client workstation security enhancement device 10 processing the data, for example unique identification value could be used to enable connecting several client workstation security enhancement devices 10 serially.

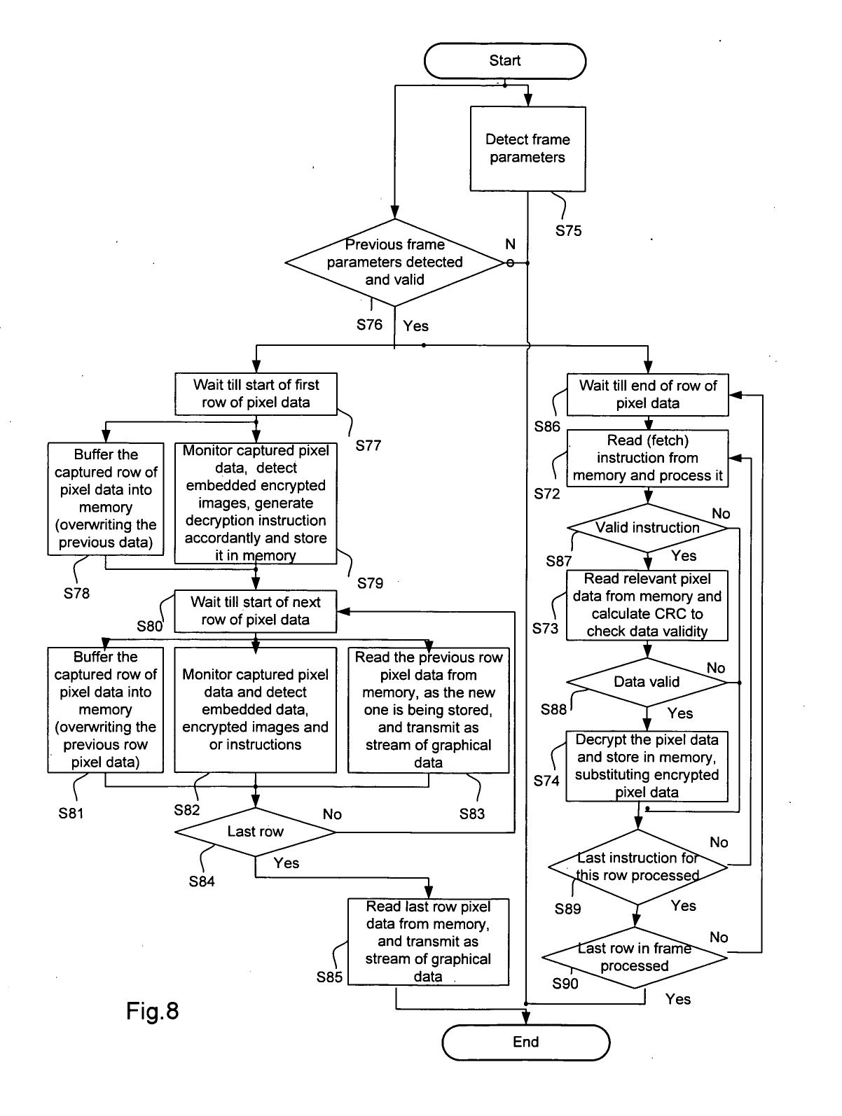

FIG. 8 illustrates an exemplary flow diagram of client workstation security enhancement device 10 processing a frame of graphical data stream that could include encrypted image/s 15.

Conveniently, as illustrated in FIG. 8, the process could start with valid graphical data stream received at RX PHY circuitry 55, for example from graphical interface circuitry 58 of client computer 9. Conveniently, RX PHY circuitry 55 could provide the captured data to other circuitries of client workstation security enhancement device 10 through such signals as red color pixel data (RED_PIX_DATA[7:0]), green color pixel data (GREEN_PIX_DATA[7:0]), blue color pixel data (BLUE_PIX_DATA[7:0]), vertical synchronization (VSYNC), horizontal synchronization (HSYNC), pixel data enable (DE), pixel clock (ODCLK), and etc., Frame start, and, additionally or alternatively, various other parameters of graphical data stream, for example such as width, and, additionally or alternatively, height of frame in pixels, and, additionally or alternatively, waveform and timing of vertical synchronization signal (VSYNC), and, additionally or alternatively, horizontal synchronization signal (HSYNC), could be detected by frame parameters analyzing circuitry 68 and indicated by various signals to other circuitries of client workstation security enhancement device 10 (S75). Then at a start of every new frame if frame is detected as valid by frame parameters analyzing circuitry 68, frame parameters analyzing circuitry 68 indicates frame start to other circuitries of workstation security enhancement device 10 and provides various frame defining parameters (S76). Then with start of first row of pixel data (S77) graphical receiving and buffering circuitry 65 could buffer the captured row of pixel data into memory 66 (S78) while, in parallel, data analyzer and instruction processing circuitry 67 could monitor the captured pixel data, for example as it's being buffered into memory 66, and detect embedded data, for example of encrypted image/s 15, in captured data. For example, data analyzer and instruction processing circuitry 67 could detect encrypted image 15 header data 29 by monitoring for predetermined patters in pixel data, patterns that could indicate that header data 29 is embedded in the captured pixels. For example, if header data 29 indicates start of encrypted image 15, the data analyzer and instruction processing circuitry 67 could process header data 29, that could include checking CRC of header data 29 for example to check header 29 validity, and, additionally or alternatively, comparing this client workstation security enhancement device 10 unique identification value and unique identification value that could be embedded in header data 29 as a pointer to client workstation security enhancement device 10 that intended to process this encrypted image 15. For example, various data and instructions embedded in header data 29 could be formed as instruction and stored into memory 66 by data analyzer and instruction processing circuitry 67 for example to be executed by decryption and execution circuitry 69 (S79). Then with the start of next row of captured pixel data (S80), the graphical receiving and buffering circuitry 65 could buffer the new captured row of pixel data overwriting the previous row pixel data in memory 66 (S81), the previous row of pixel data as being overwritten could be read out by graphical data transmitting circuitry 70 and in accordance with various frame parameters provided by data analyzer and instruction processing circuitry 67 transmitted as graphical data stream via TX PHY circuitry 56 for example to display device 6 (S83), while the captured new row of pixel data is also being processed by data analyzer and instruction processing circuitry 67 as it's being buffered into memory 66 (S82), then Conveniently, all captured rows of a single frame could be processed in similar manner, till last row been processed (S84), then the graphical data transmitting circuitry 70 could read the last pixel data row of the frame from memory 66 and transmit as last row of graphical data stream via TX PHY circuitry 56 (S85).

Conveniently, as illustrated in FIG. 8, in parallel, with start of every new valid frame (S76) and after completion of every row of pixel data capture, analysis and buffering into memory 66 for example by circuitries of graphical data receiving and buffering circuitry 65 and data analyzer and instruction processing circuitry 67 (S86), decryption and execution circuitry 69 could read instruction from instruction area in memory 66, that for example could have been generated by data analyzer and instruction processing circuitry 67 (S72), analyze the fetched instruction and if the instruction is valid (S87), decryption and execution circuitry 69 could start executing the instruction by for example performing the acts of reading the relevant slice of pixel data for example data of thirty two pixels, calculate CRC values for the read pixel data slice for example to check if they match to the CRC values that could be embedded for example in pixel data for example of encrypted image 15, such comparison could indicate if the processed slice of pixel data is part of encrypted image 15 pixel data and not for example cursor 52 pixel data and, additionally or alternatively, window 53 pixel data overlaying the encrypted image 15 pixel data, for example the CRC values may be calculated using various mathematical techniques used to generate a digital (comparison) signature that could be embedded in encrypted image 15, and, additionally or alternatively, by other suitable method (S73), then if pixel data is preserved as valid embedded encrypted image 15 pixel data (S88) for example the acts of decryption, inverse scramble data word generation, XOR of decryption result with inverse scramble data word, and, additionally or alternatively, decryption and XOR acts result storage in memory 66 could be performed (S74) and with completion of instruction execution the decryption and execution circuitry 69 could move to execute the next instruction in memory 66 till all instructions in instruction area in memory 66 are executed (S89), then, with capture completion of a new row of pixel data, instructions in instruction memory 66 could be processed, and, additionally or alternatively, executed in similar manner and till all rows of the frame been processed (S90).

Conveniently, as one of the acts of instruction execution, for example from instruction area in memory 66, by decryption and execution circuitry 69, executed instruction could be modified by decryption and execution circuitry 69 and stored in instruction area in memory 66, for example overwriting the executed instruction, for example to be executed during pass of the next row of pixel.

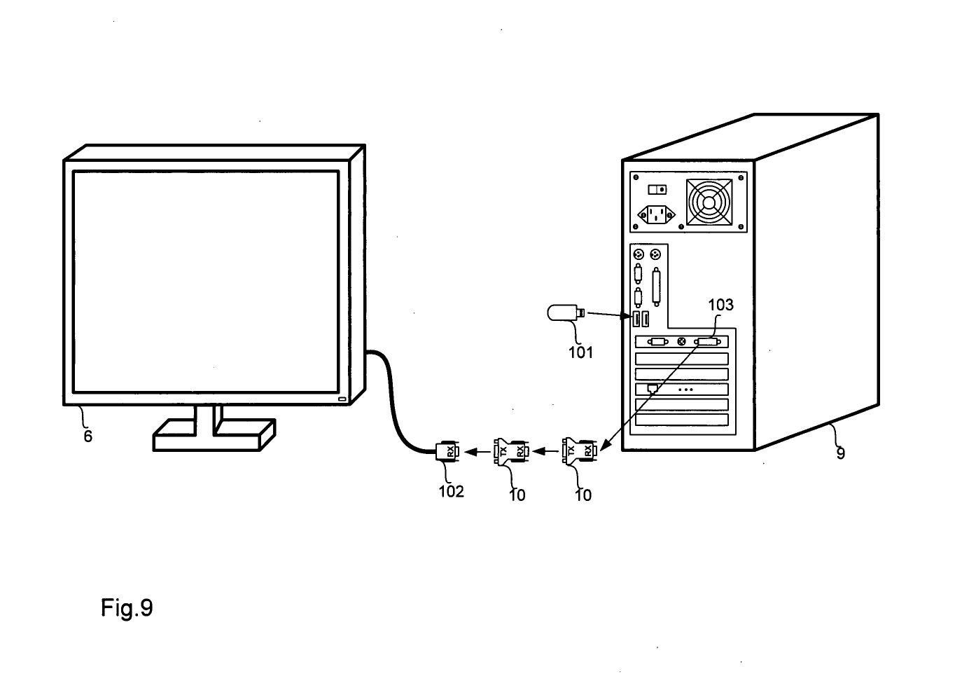

FIG. 9 illustrates an exemplary perspective view of computer system with client workstation security enhancement device 10, and, additionally or alternatively, with client security enhancement dongle device 101, according to another embodiment of the invention.

Conveniently, as illustrated in FIG. 9 for example in some embodiments of present invention client workstation security enhancement device 10 could be embodied as a plug that could link between computer 9 graphical interface connector 103, for example DVI interface connector of computer 9, and display device 6 graphical data interface cable 102. Conveniently, as illustrated in FIG. 9 for example in some embodiments of present invention one or more client computer security enhancement device 10 plugs of various embodiments could link (plug) serially to each other. Conveniently, client workstation security enhancement device 10 could apply various methods and, additionally or alternatively, techniques on data exchanged, via the device 10, between computer 9 and display device 6. Conveniently, as illustrated in FIG. 9 for example client security enhancement dongle device 101 could be provided that could for example be embodied as plug (dongle) that could link (plug) to computer 9, for example via USB interface. Conveniently, client security enhancement dongle device 101 could for example store decryption keys that could be applied by client workstation security enhancement device 10, for example such decryption keys could be transmitted from client security enhancement dongle device 101 to client workstation security enhancement device 10 for example as data embedded in encrypted image that could for example be displayed as icon 54 on desktop view 51.

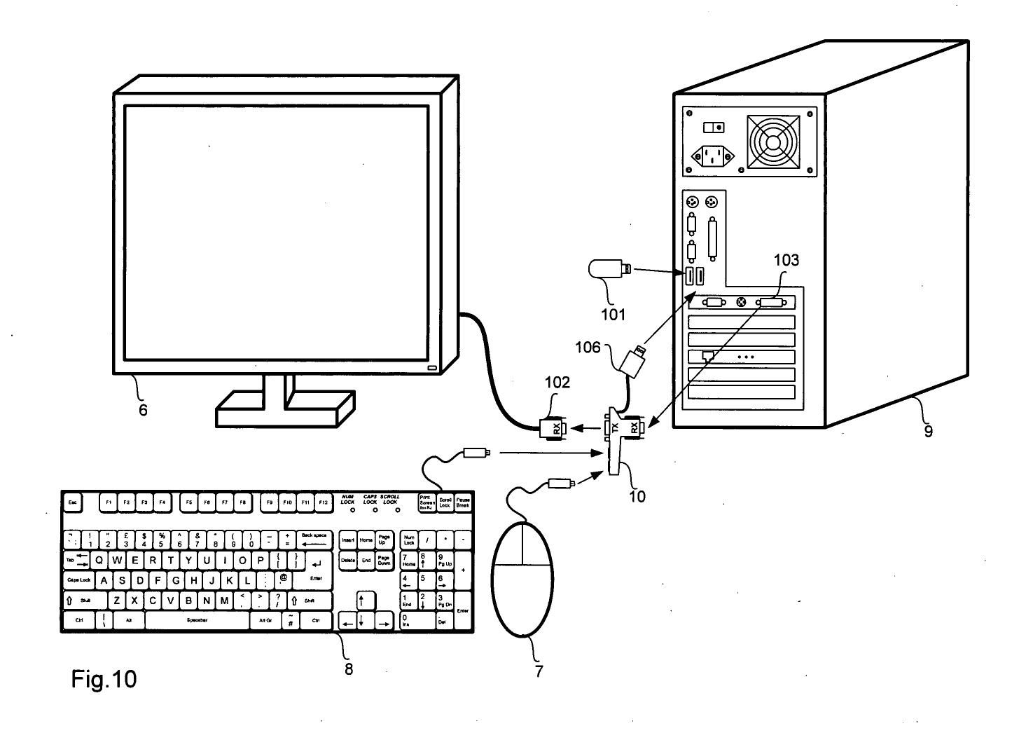

FIG. 10 illustrates an exemplary perspective view of computer system with client computer security enhancement device 10, and, additionally or alternatively, with mouse device 7, and, additionally or alternatively, with keyboard device 8, and, additionally or alternatively, with client security enhancement dongle device 101, according to another embodiment of the invention.

Conveniently, as illustrated in FIG. 10 for example in some embodiments of present invention client workstation security enhancement device 10 could be embodied as a plug that could link between computer 9 graphical interface connector 103 for example DVI interface connector, and display device 6 graphical interface cable 102, and, additionally or alternatively, for example client workstation security enhancement device 10 plug could link to various computer 9 interfaces via cable 106 for example to PS/2, and, additionally or alternatively, USB interfaces of computer 9, and, additionally or alternatively, for example client workstation security enhancement device 10 plug could link to keyboard device 8, and, additionally or alternatively, to mouse device 7. Conveniently, in some embodiments of present invention one or more client computer security enhancement devices 10 various embodiments could link (plug) serially to each other. Conveniently, client computer security enhancement device 10 could apply various methods and techniques on data exchanged, via the device 10, between computer 9 and display device 6, and, additionally or alternatively, on data exchanged, via the device 10, between computer 9 and, additionally or alternatively, keyboard device 8, and, additionally or alternatively, mouse device 7.

Conveniently, as illustrated in FIG. 10 for example client security enhancement dongle device 101 could be provided that could for example be embodied as plug (dongle) that could link (plug) to computer 9, for example via USB interface. Conveniently, client security enhancement dongle device 101 could store decryption keys that could be applied by client workstation security enhancement device 10, for example such decryption keys could be transmitted from client security enhancement dongle device 101 to client workstation security enhancement device 10 for example as data embedded in encrypted image that could be displayed as icon 54 on desktop view 51.

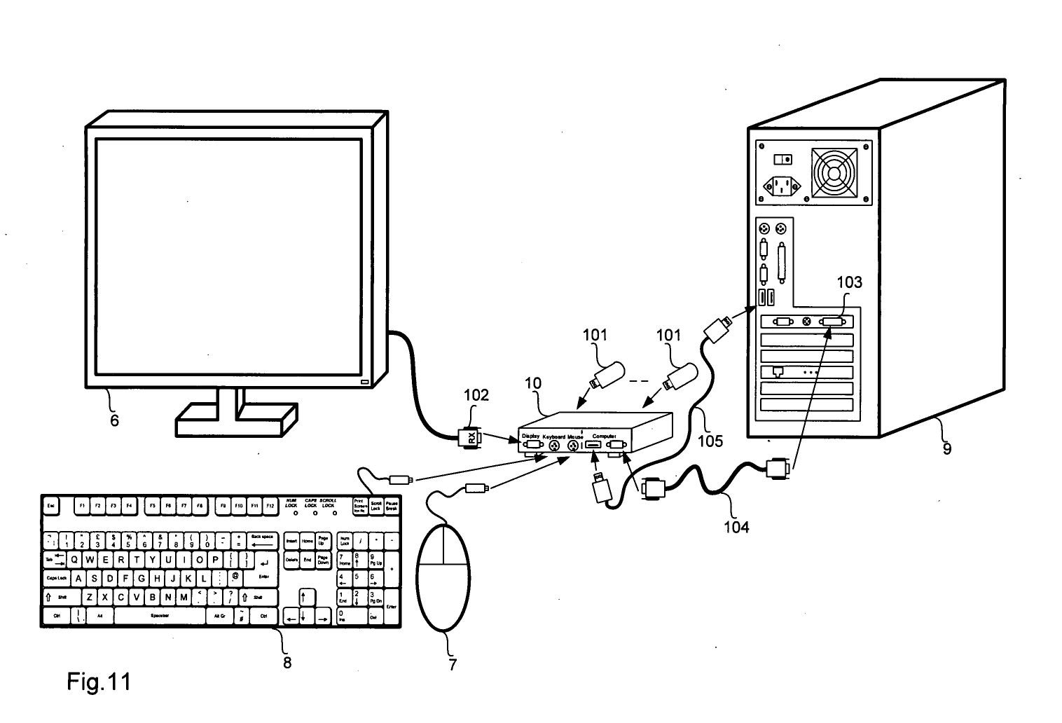

FIG. 11 illustrates an exemplary perspective view of computer system with client workstation security enhancement device 10 for example embodied as desktop box, and, additionally or alternatively, client security enhancement dongle device 101, according to another embodiment of the invention.

Conveniently, as illustrated in FIG. 11 for example in some embodiments of present invention client workstation security enhancement device 10 could be embodied as a desktop box that could link between computer 9 graphical interface connector 103 for example DVI interface connector, and display device 6 graphical interface cable 102, and, additionally or alternatively, for example client workstation security enhancement device 10 desktop box could link to various computer 9 interfaces via cable 105 for example to PS/2 and, additionally or alternatively, USB interfaces of computer 9, and, additionally or alternatively, for example client workstation security enhancement device 10 desktop box could link to keyboard device 8, and, additionally or alternatively, mouse device 7. Conveniently, client workstation security enhancement device 10 could link to computer 9 graphical interface connector 103 via cable 104. Conveniently, in some embodiments of present invention one or more client workstation security enhancement device 10 of various embodiments could link (plug) serially and, additionally or alternatively, in parallel to each other 10. Conveniently, client computer security enhancement device 10 could apply various methods and techniques on data exchanged, via the device 10, between computer 9 and display device 6, and, additionally or alternatively, on data exchanged, via the device 10, between computer 9 and keyboard device 8, and, additionally or alternatively, mouse device 7.

Conveniently, as illustrated in FIG. 11 for example client security enhancement dongle device 101 could for example be embodied as plug (dongle) that could link (plug) to computer 9 for example via USB interface, and, additionally or alternatively, client security enhancement dongle device 101 could link (plug) to client computer security enhancement device 10 for example via USB interface. Conveniently, client security enhancement dongle device 101 could provide secure storage for various data for example decryption keys, and, additionally or alternatively, client security enhancement dongle device 101 could provide data processing and, additionally or alternatively, applications execution services, that could be applied by client workstation security enhancement device 10. Conveniently, one or more client security enhancement dongle device 101 could link to computer 9 and, additionally or alternatively, to client computer security enhancement device 10 at a time.

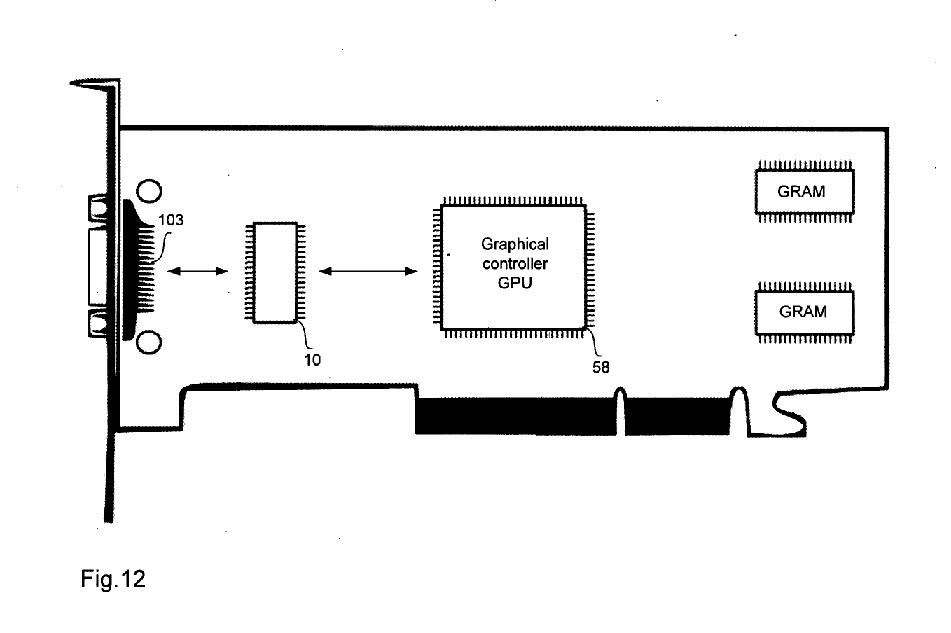

FIG. 12 illustrates an exemplary perspective view of graphical card with client computer security enhancement device 10 for example embodied as integrated circuit IC chip.

Conveniently, as illustrated in FIG. 12 for example client workstation security enhancement device 10 could be embodied as integrated circuit IC chip and could link between graphical card interface connector 103 and graphical controller circuitry IC chip 58. Conveniently, in some embodiments, graphical controller circuitry IC chip 58 and graphical interface connector 103 and client workstation security enhancement device 10 (that could be embodied as integrated circuit IC chip) could be part of motherboard circuitry.

Conveniently, as a method for user authentication (login), login (access) verification password that could include numbers and, additionally or alternatively, letters could be randomly generated, graphically represented as image 14 and converted into encrypted image 15 by server 12, and, additionally or alternatively, by security enhancement server 13, and, additionally or alternatively, by client security enhancement dongle device 101, then transmitted to client computer 9 and displayed on desktop view 51, then processed by client workstation enhancement security device 10 and displayed as plain image on display device 6 of client workstation 1 to graphically display the login verification password in secure manner, then user could be asked to type in the generated login verification password to login (gain access), this for example could prevent from unauthorized users 3 to login since they can't see the decryption result of encrypted image 15 that contains the graphical representation of login verification password.

Conveniently, as a method for entering numerical data in a secure manner for example credit card number, one or more randomly generated digits could be graphically represented in plain image 14, then the plain image 14 could be converted into encrypted image 15 by server 12, and, additionally or alternatively, by security enhancement server 13, and, additionally or alternatively, by client security enhancement dongle device 101, then transmitted to client computer 9 and displayed on desktop view 51, then processed by client workstation enhancement security device 10 and displayed on display device 6 of client workstation 1, graphically displaying the graphical representation of randomly generated digits in secure manner, then the user could, in various ways, provide for example the difference between displayed random number/s and the desired number to be entered by him/here. For example, a digit “7” could be randomly generated by server 12, and, additionally or alternatively, by security enhancement server 13, and, additionally or alternatively, by client security enhancement dongle device 101, then graphically represented and converted into encrypted image 15, then such image 15 could be sent to client computer 9, displayed on desktop view 51, processed by client workstation enhancement security device 10 and displayed on display device 6 of client workstation 1 to graphically display the digit “7” in a secure manner, then the user that for example prefers to enter a digit value of “3” could for example click that the digit he wants to enter is the displayed digit minus four.

Conveniently, as a method for entering numerical data in a secure manner, for example credit card number, one or more sets of ten digits from zero to nine could be graphically represented in plain image 14 at random order for example graphical representation of digits could be randomly placed (positioned) in image 14, then such image 14 could be converted into encrypted image 15, then such image 15 could be sent to client computer 9, displayed on desktop view 51, processed by client workstation enhancement security device 10 and displayed on display device 6 of client workstation 1 to graphically display the digits in a secure manner, then the user could for example clink on the desired to be entered digit as displayed on display device 6 providing relative location of desired to be entered digit and the relative location (position) of click over the image could be applied by server 12, and, additionally or alternatively, by security enhancement server 13, and, additionally or alternatively, by client security enhancement dongle device 101, to extract, from the relative click position, information about the desired digit to be entered by user.

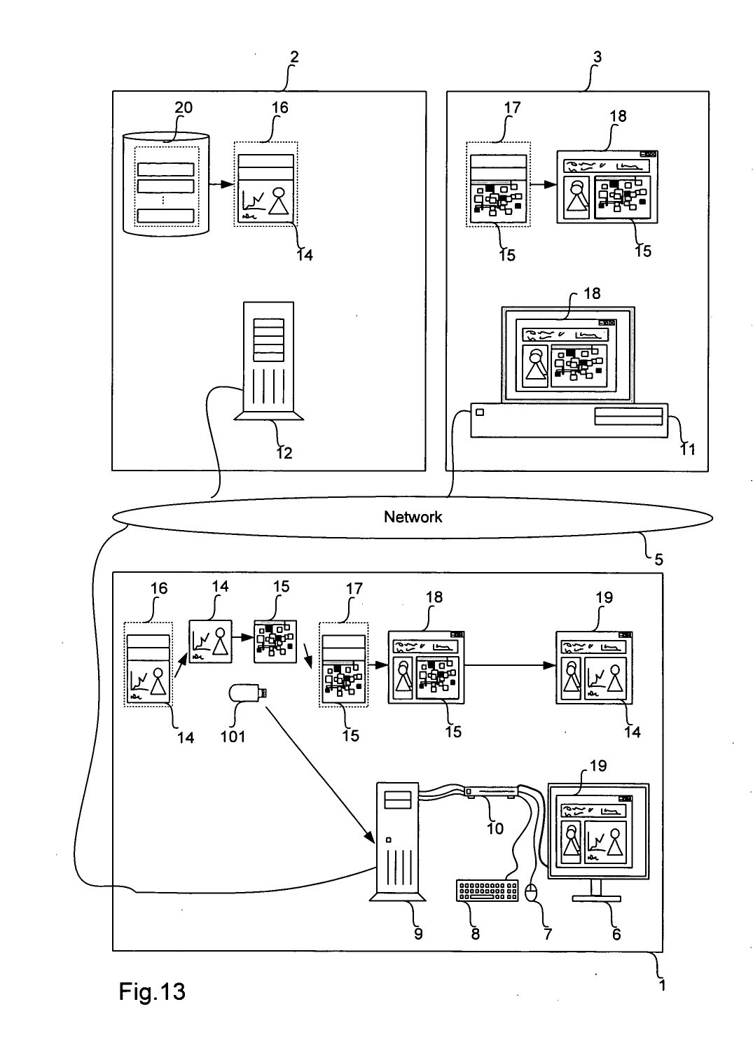

Conveniently, FIG. 13 illustrates an exemplary block diagram of computer-based systems connecting over network 5 according to another embodiment of the invention, provides client security enhancement dongle device 101, and, additionally or alternatively, provides client workstation enhancement security device 10, and, additionally or alternatively, provides method and, additionally or alternatively, technique for maintaining secure data access and, additionally or alternatively, data exchange between computer-based systems and, additionally or alternatively, provides method and, additionally or alternatively, technique for secure execution of applications.

Conveniently, as logically illustrated in FIG. 13, for example client computer 9 could request access to various data 20 stored on server 12 over network 5, such request could cause server 12 to access the requested data in data storage 20, and, additionally or alternatively, could cause server 12 to package the requested data as data packet 16 containing data in various formats, for example text, graph, image, table, etc., then such data packet/s 16 could be sent in secure manner, for example by applying various encryption techniques, to client security enhancement dongle device 101 linked to computer 9 in a secure manner, then client security enhancement dongle device 101 could convert all or parts of the data in data packet 16 into their graphical representation plain image 14, and, additionally or alternatively, client security enhancement dongle device 101 could convert plain image 14 into encrypted image 15, and, additionally or alternatively, client security enhancement dongle device 101 could replace plain image 14 in data packet 16 with encrypted image 15 to form data packet 17 containing encrypted image 15, and, additionally or alternatively, could send data packet 17 to client computer 9. Conveniently, as logically illustrated in FIG. 13, for example client computer 9, could receive data packet 17 from client security enhancement dongle device 101, received data packet 17 could include (contain) encrypted image 15 data, client computer 9 then could for example graphically represent received data in data packet 17 as graphical representation image 18 that could include graphical representation of encrypted image 15, client computer 9 then could for example display the image 18 on desktop view 51.

Conveniently, as logically illustrated in FIG. 13, plain image 14 from data packet 16 could be converted into encrypted image 15 by client security enhancement dongle device 101 for example by replacing plain image pixel data with encrypted pixel data, then for example data packet 16 could be converted into data packet 17 by replacing plain image 14 data with encrypted image 15 data.

Conveniently, various transfers of data between server 12 and client security enhancement dongle device 101 could be performed in a secure manner, for example by encrypting, and, additionally or alternatively, signing exchanged data.

Conveniently, for the purposes of this description, the term converting plain image 14 into encrypted image 15 could refer to any mechanism or technique for transforming or hiding valid data of plain image 14 so that the valid data becomes difficult to view, intercept, process, or modify without proper authorization and thus, appears as invalid data when accessed in an unauthorized manner. Conveniently, conversion techniques may be implemented as software, hardware, circuitry, and, additionally or alternatively, firmware.

Conveniently, for the purposes of this description, it should be understood that references to various acts taken, and, additionally or alternatively, operations performed by client security enhancement dongle device 101 could refer to acts taken, and, additionally or alternatively, operations performed by client security enhancement dongle device 101 various hardware and, additionally or alternatively, circuitry, and, additionally or alternatively, could refer to acts taken, and, additionally or alternatively, operations performed by various applications running on client security enhancement dongle device 101.

Conveniently, data packet 17 received on client computer 9 from client security enhancement dongle device 101 could be graphically represented as image 18 by client computer 9 to be displayed, while for example graphical representation 18 could contain full or partial graphical representation of encrypted image 15.

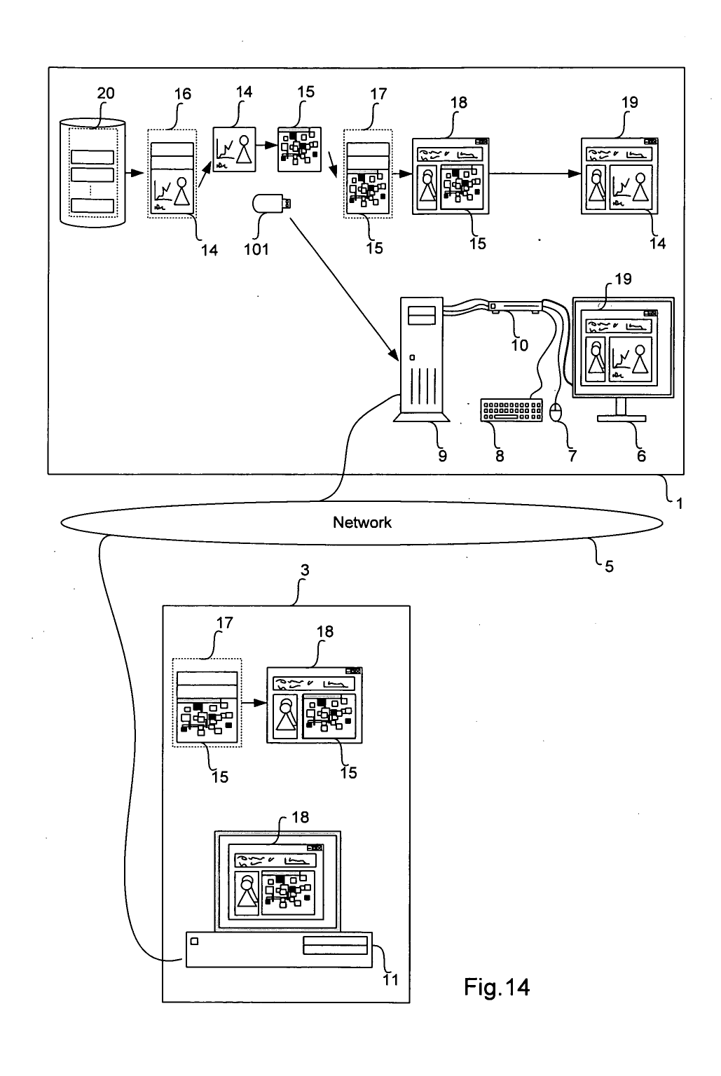

Conveniently, FIG. 14 illustrates an exemplary block diagram of computer-based system according to another embodiment of the invention, provides client security enhancement dongle device 101, and, additionally or alternatively, provides client workstation enhancement security device 10, and, additionally or alternatively, provides method and, additionally or alternatively, technique for maintaining secure data access and, additionally or alternatively, data exchange, and, additionally or alternatively, provides method and, additionally or alternatively, technique for secure execution of applications.

Conveniently, as logically illustrated in FIG. 14, for example client computer 9 could request access to various data 20 that could be stored on client security enhancement dongle device 101, such request could cause client security enhancement dongle device 101 to access the requested data 20 in data storage, and, additionally or alternatively, could cause client security enhancement dongle device 101 to package the requested data as data packet 16 containing data in various formats, for example text, graph, image, table, etc., then such data packet/s 16, then client security enhancement dongle device 101 could convert all or parts of the data in data packet 16 into their graphical representation plain image 14, and, additionally or alternatively, client security enhancement dongle device 101 could convert plain image 14 into encrypted image 15, and, additionally or alternatively, client security enhancement dongle device 101 could replace plain image 14 in data packet 16 with encrypted image 15 to form data packet 17 containing encrypted image 15, and, additionally or alternatively, could send data packet 17 to client computer 9. Conveniently, as logically illustrated in FIG. 14, for example client computer 9, could receive data packet 17 from client security enhancement dongle device 101, received data packet 17 could include (contain) encrypted image 15 data, client computer 9 then could for example graphically represent received data in data packet 17 as graphical representation image 18 that could include graphical representation of encrypted image 15, client computer 9 then could for example display the image 18 on desktop view 51.

Conveniently, as logically illustrated in FIG. 14, plain image 14 from data packet 16 could be converted into encrypted image 15 by client security enhancement dongle device 101 for example by replacing plain image pixel data with encrypted pixel data, then for example data packet 16 could be converted into data packet 17 by replacing plain image 14 data with encrypted image 15 data.

Conveniently, data packet 17 received on client computer 9 from client security enhancement dongle device 101 could be graphically represented as image 18 by client computer 9 to be displayed, while for example graphical representation 18 could contain full or partial graphical representation of encrypted image 15.

According to an aspect of the invention, a client workstation enhancement security device 10 is disclosed, the client workstation enhancement security device 10 includes: (a) a first port for connecting by a communication connection the client workstation enhancement security device 10 to a client computer 9, (b) a second port for connecting by a communication connection the client workstation enhancement security device 10 to a target system (that Conveniently, includes a displaying means, or is able to process graphical data), and (c) a processor, adapted to decrypt encrypted image information received via the first port, so as to provide a decrypted image information, and to transmit the decrypted image information via the second port.

It is noted that conveniently, all the graphical information that is transmitted from the client computer 9 to the target system is transmitted via the client workstation enhancement security device 10. It is however noted that not all the graphical information transmitted from the client computer 9 to the target system is necessarily encrypted, and that encrypted graphical information may be used only for some of the graphical information (e.g. when the graphical information is determined sensitive, when it is used for sensitive processes such as authentication, etc.)

Conveniently, client workstation enhancement security device 10, and especially the processor thereof, is adapted to distinguish between encrypted graphical information and not-encrypted graphical information, and to process (i.e. to decrypt) only encrypted image information. It is noted that the encrypted image information may relate to any type of image, and is usually referring to information ready to be displayed by the target system (i.e. relates to pixel data).

According to an embodiment of the invention, client workstation enhancement security device 10 is further adapted to process one or more type of instructions that are provided either embedded within a received image information (either encrypted or not) or otherwise. Examples for such instructions are loading of secret keys into client workstation enhancement security device 10 from a server, altering a graphical view of decrypted image (for example draw a cursor on decrypted image in a dynamically set position), and so forth.

According to an embodiment of the invention, the processor is adapted to decrypt the encrypted image information by carrying out at least some of the following processes: (a) capturing graphical data stream transmitted by client computer 9, (b) detecting and processing various embedded instructions in graphical data stream, (c) detecting encrypted images 15 in captured graphical data stream, (d) decrypting encrypted image information (e.g. encrypted image pixel data) into decrypted image information (e.g. encrypted image pixel data), (e) substituting in captured graphical data stream encrypted image information with decrypted image information, (f) transmitting processed graphical data stream (for example in DVI format) to the target system.

It is noted that according to some embodiments of the invention, client workstation enhancement security device 10 could be implemented as separate computer-based system, or as device or a circuitry that is either stand alone, or is implemented either into client computer 9, or to the target system, etc.

It is noted that, according to an embodiment of the invention, the encrypted image information is received from client computer 9 that can not decrypt the encrypted image information, wherein the encrypted image information is Conveniently, then provided to the client computer 9 from an encrypting server.

According to different embodiments of the invention, an encrypting server that provides the encrypted image information to client computer 9 can be either a remote server (e.g. over a network, that may be either wired, wireless, or combined network), or a device adapted to directly connect to client computer 9, such as USB dongle device 101, that is described above, and is Conveniently, adapted to run internally an encryption software.

According to an embodiment of the invention, client workstation enhancement security device 10 further includes one or more additional ports for connecting peripheral input devices (e.g. a mouse device 7, a keyboard 8, and so forth) to client computer 9. Conveniently, client workstation enhancement security device 10 is adapted to transmit to client computer 9 information responsive to information received from at least one peripheral device (e.g. mouse movement, mouse clicks or keyboard strokes), wherein the information transmitted may be either encrypted, partially encrypted or not encrypted. Additionally, according to an embodiment of the invention, client workstation enhancement security device 10 is adapted to add a signature information to information transmitted in response to information that is received from one or more peripheral device. It is noted that, according to an embodiment of the invention, client workstation enhancement security device 10 is adapted to encrypt information received from a peripheral device (or a signature associated with such information) by an encryption that is not decryptable by client computer 9.

It is however noted that client workstation enhancement security device 10 may not include the one or more additional ports, and that conveniently, if client workstation enhancement security device 10 includes the one or more additional ports, client workstation enhancement security device 10 can operate even if some or all of the additional ports are not connected to peripheral devices, or are connected to peripheral devices that are not fully functional.

According to an embodiment of the invention, client workstation security enhancement device 10 is adapted to be connected to at least one of display device 6, keyboard device 8, mouse device 7, and client computer 9 in a manner that enables client workstation security enhancement device 10 to carry out at least some of the following processes: capturing, buffering, analyzing, processing, modifying, and, additionally or alternatively, adding data to data transferred between any two of the abovementioned components.

According to an embodiment of the invention, client workstation enhancement security device 10 is adapted to analyze received data that is received from one or more system or components connected thereto, to determine if the received data is encrypted or not, wherein a decryption of the received data by client workstation enhancement security device 10 is responsive to a result of the determining.

Although the present invention has been described with respect to exemplary embodiments, it will be understood that the present described embodiments are therefore to be considered in all respects as illustrative and not restrictive. I claim the apparatus and the method of operation described above.

Although the present invention has been described with respect to exemplary embodiments, it will be understood that the present described embodiments are therefore to be considered in all respects as illustrative and not restrictive. I claim the apparatus and the method of operation described above.

What is claimed is:

1. A hardware device that comprises a first interface, a second interface, at least one memory unit, a data analyzer circuitry, and decryption circuitry;
wherein the first interface receives image information that is sent to a display;
wherein the data analyzer circuitry analyzes the image information to detect encrypted image information;
wherein the decryption circuitry decrypts the detected encrypted image information to provide the decrypted image information to replace the encrypted image information to provide modified image information;
wherein the second interface sends the modified image information to the display so that the display displays a modified image; and
wherein the at least one memory unit stores at least a portion of at least one out of the image information and the modified image information; and at least one decryption key.

2. The hardware device according to claim 1 wherein the hardware device is a hardware plug.

3. The hardware device according to claim 1 wherein the hardware device is an integrated circuit that is embedded in a computer of a user.

4. The hardware device according to claim 1 further comprising at least one port for providing connectivity with peripheral input device of a user and at least one port for providing connectivity with a computer of a user.

5. The hardware device according to claim 1 wherein encrypted image information is representative of an encrypted instruction that assists the decryption circuitry to decrypt an image represented by another encrypted image information.

6. The hardware device according to claim 1 wherein the data analyzer searches for a predefined data structure within the image information that is indicative of encrypted image information; wherein the predefined data structure comprises at least one data entity selected from decryption key pointer, a size of an encrypted image, an instruction, and CRC value.

7. The hardware device according to claim 1 wherein the data analyzer circuitry verifies which slices of the detected encrypted image information are correctly represented in image information and which slices are overlaid by other graphics or invalid.

8. The hardware device according to claim 1 wherein the data analyzer determines validity of slices of pixel information of the detected encrypted image information by calculating pixel information error detecting CRC value and comparing it with the expected CRC value.

9. The hardware device according to claim 1 wherein the decryption circuitry decrypts valid encrypted image information and modifies image information.

10. The hardware device according to claim 1 wherein the encrypted image information comprises multiple slices; wherein the decryption circuitry decrypts one slice after the other.

11. The hardware device according to claim 1 wherein the decryption circuitry processes the encrypted image information by performing de-scrambling, decryption and modification.

12. A method for secure communication, the method comprises:
receiving by first interface of a hardware device, image information that is sent to a display;
analyzing, by a data analyzer circuitry of the hardware device, the image information to detect and validate encrypted image information;
decrypting, by a decryption circuitry of the hardware device, the encrypted image information to provide decrypted image information;
modifying, by the hardware device, the decrypted data information to provide modified decrypted image information;
replacing, by the hardware device, the encrypted image information by the modified decrypted image information to provide modified image information;
sending, by a second interface of the hardware device, the modified image information to the display so that the display displays a modified image information;
storing, in at least one memory unit of the hardware device, at least a slice of the image information and the modified image information and storing at least one decryption key.

13. The method according to claim 12 wherein the receiving is by a hardware device that is a hardware plug.

14. The method according to claim 12 wherein the receiving is by a hardware device that is an integrated circuit that is embedded in a computer of a user.

15. The method according to claim 12, wherein the receiving is by a hardware device that comprises at least one port for providing connectivity with peripheral input device of a user and at least one port for providing connectivity with a computer of a user.

16. The method according to claim 12 wherein the decrypting is of encrypted image information that is representative of an encrypted instruction that assists the decryption circuitry to decrypt an image represented by another encrypted image information.

17. The method according to claim 12 wherein the analyzing further comprising searching for a predefined data structure within the image information that is indicative of encrypted image information and wherein the predefined data structure comprises at least one data entity selected from decryption key pointer, a size of an encrypted image, an instruction, and CRC value.

18. The method according to claim 12 wherein the analyzing further comprising verifying which slices of the detected encrypted image information are correctly represented in image information and which slices are overlaid by other graphics or invalid.

19. The method according to claim 12 wherein the analyzing further comprising determining validity of slices of pixel information of the detected encrypted image information by calculating pixel information error detecting CRC value and comparing it with the expected CRC value.

20. The method according to claim 12 wherein the decrypting further comprising decrypting of valid encrypted image information and modifying image information.

21. The method according to claim 12 wherein the encrypting is of an encrypted image information that comprises multiple slices and wherein the decrypting is done one slice after the other.

22. The method according to claim 12 wherein the decrypting further comprising processing the encrypted image information by performing de-scrambling, decryption and modification.
